(19) United States
(12) Patent Application Publication
(10) Pub. No.: US 2012/0127869 A1
(43) Pub. Date: May 24, 2012

(54) MULTIPLE CHANNEL STATE INFORMATION (CSI) REPORTING ON THE PHYSICAL UPLINK SHARED CHANNEL (PUSCH) WITH CARRIER AGGREGATION

(75) Inventors: Zhanping Yin, Vancouver, WA (US); Shohei Yamada, Camas, WA (US); Ahmad Khoshnevis, Portland, OR (US); Sayantan Choudhury, Vancouver, WA (US); John M. Kowalski, Camas, WA (US)

(73) Assignee: Sharp Laboratories of America, Inc., Camas, WA (US)

(21) Appl. No.: 12/952,114

(22) Filed: Nov. 22, 2010

(51) Int. Cl. H04J 1/16; H04W 24/10

(52) U.S. Cl. 370/252

(57) ABSTRACT

A method for reporting uplink control information (UCI) by a user equipment (UE) is described. It is determined that multiple channel state information (CSI) reports are scheduled on a physical uplink shared channel (PUSCH). An aggregated CSI report is generated using two or more of the multiple CSI reports. The aggregated CSI report is transmitted on the PUSCH.

### TECHNICAL FIELD

The present invention relates generally to wireless communications and wireless communications-related technology. More specifically, the present invention relates to systems and methods for multiple channel state information (CSI) reporting on the physical uplink shared channel (PUSCH) with carrier aggregation.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station may be a fixed station that communicates with mobile stations.

Various signal processing techniques may be used in wireless communication systems to improve efficiency and quality of wireless communication. One such technique may include using simultaneous physical uplink control channel (PUCCH) and physical uplink shared channel (PUSCH) transmissions. Benefits may be realized by using different uplink control information (UCI) reporting for simultaneous physical uplink control channel (PUCCH) and physical uplink shared channel (PUSCH) transmissions and non-simultaneous physical uplink control channel (PUCCH) and physical uplink shared channel (PUSCH) transmissions.

### BRIEF DESCRIPTION OF THE DRAWINGS

FIG. 1 is a block diagram illustrating a wireless communication system using uplink control information (UCI) multiplexing;

FIG. 2 is a block diagram illustrating transmissions from a user equipment (UE) to an eNode B during a subframe;

FIG. 3 is a block diagram illustrating the layers used by a user equipment (UE);

FIG. 4 is a flow diagram of a method for transmitting periodic channel state information (CSI) reports on the physical uplink shared channel (PUSCH);

FIG. 5 is a flow diagram of a method for transmitting multiple periodic channel state information (CSI) reports on the physical uplink shared channel (PUSCH);

FIG. 6 is a flow diagram of a method for concatenating multiple periodic channel state information (CSI) reports that are CQI/PMI to obtain an aggregated CQI/PMI of an aggregated channel state information (CSI) report;

FIG. 7 is a flow diagram of a method for concatenating multiple periodic channel state information (CSI) reports that are rank indication (RI) to obtain an aggregated rank indication (RI) of an aggregated channel state information (CSI) report;

FIG. 8 is a flow diagram of a method for transmitting aperiodic channel state information (CSI) reports on the physical uplink shared channel (PUSCH);

FIG. 9 is a flow diagram of a method for concatenating multiple component carrier (CC) specific aperiodic channel state information (CSI) reports to obtain an aggregated channel state information (CSI) report;

FIG. 10 is a flow diagram of a method for transmitting uplink control information (UCI) on the physical uplink shared channel (PUSCH);

FIG. 11 is a flow diagram of a method for generating an aggregated channel state information (CSI) report using combined rank indication (RI) from an instance of aperiodic channel state information (CSI) report and one or more periodic channel state information (CSI) reports;

FIG. 12 is a flow diagram of a method for generating an aggregated channel state information (CSI) report using combined CQI/PMI from an instance of aperiodic channel state information (CSI) report and one or more periodic channel state information (CSI) reports;

FIG. 13 is a flow diagram of another method for transmitting uplink control information (UCI) on the physical uplink shared channel (PUSCH);

FIG. 14 is a flow diagram of a method for generating an aggregated channel state information (CSI) report using combined CQI/PMI from an aperiodic channel state information (CSI) report that is for a specific downlink component carrier (CC) and one or more periodic channel state information (CSI) reports;

FIG. 15 is a flow diagram of a method for generating an aggregated channel state information (CSI) report using combined rank indication (RI) from an aperiodic channel state information (CSI) report and one or more periodic channel state information (CSI) reports;

FIG. 16 is a flow diagram of a method for transmitting an extended aperiodic channel state information (CSI) report;

FIG. 17 is a flow diagram of a method for generating an extended aperiodic channel state information (CSI) report;

FIG. 18 illustrates various components that may be utilized in a user equipment (UE); and

FIG. 19 illustrates various components that may be utilized in an eNode B.

### DETAILED DESCRIPTION

A method for reporting uplink control information (UCI) by a user equipment (UE) is disclosed. It is determined that multiple channel state information (CSI) reports are scheduled on a physical uplink shared channel (PUSCH). An aggregated CSI report is generated using two or more of the multiple CSI reports. The aggregated CSI report is transmitted on the PUSCH.

The multiple CSI reports may include multiple periodic CSI reports. Generating an aggregated CSI report may include concatenating the multiple periodic CSI reports with component carrier (CC) ordering for each type of CSI report. Transmitting the aggregated CSI report on the PUSCH may include multiplexing multiple aggregated CSI reports on the PUSCH as one composite CSI block. A trigger from an eNode B to generate an aperiodic CSI report may be received. The multiple CSI reports may include multiple aperiodic CSI reports.

Multiple component carrier (CC) specific aperiodic CSI reports may be generated. Generating an aggregated CSI report may include concatenating the multiple CC specific aperiodic CSI reports. Transmitting the aggregated CSI report on the PUSCH may include multiplexing the aggregated aperiodic CSI report on the PUSCH. The aggregated CSI report may include an aggregated channel quality indicator (CQI) and/or precoding matrix indicator (PMI) and aggregated rank information (RI). A trigger from an eNode B to generate an instance of aperiodic CSI report may be received. The multiple CSI reports may include the instance of aperiodic CSI report and one or more periodic CSI reports.

It may be determined that multiple CSI reports on the PUSCH is supported. The aggregated CSI report may be generated using both the instance of aperiodic CSI report and the one or more periodic CSI reports. It may be determined that multiple CSI reports on the PUSCH is not supported. The aggregated CSI report may be generated using only the instance of aperiodic CSI report on the PUSCH. The method may include determining whether the aperiodic CSI report is for all configured/activated component carriers (CCs). If it is determined that the aperiodic CSI report is for all configured/activated CCs, the aggregated CSI report may be generated using only the instance of aperiodic CSI report. If it is determined that the aperiodic CSI report is not for all configured/activated CCs, the aggregated CSI report may include the instance of aperiodic CSI report and one or more periodic CSI reports.

The one or more periodic CSI reports may correspond to CCs that are not in included in the instance of aperiodic CSI report. The aggregated CSI report may be generated using an aperiodic CSI process to encode the instance of aperiodic CSI report and a periodic CSI process to encode the one or more periodic CSI reports. The aggregated CSI report may include an extended aperiodic CSI report that includes elements of the instance of aperiodic CSI report and CSI of component carriers that were not represented in the instance of aperiodic CSI report. The UE may be configured for simultaneous physical uplink control channel (PUCCH) and PUSCH transmissions.

A user equipment (UE) configured for reporting uplink control information (UCI) is also disclosed. The UE includes a processor, memory in electronic communication with the processor, and instructions stored in the memory. The instructions are executable to determine that multiple channel state information (CSI) reports are scheduled on a physical uplink shared channel (PUSCH). The instructions are also executable to generate an aggregated CSI report using two or more of the multiple CSI reports. The instructions are further executable to transmit the aggregated CSI report on the PUSCH.

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9 and Release-10). However, the scope of the present disclosure should not be limited in this regard. At least some aspects of the systems and methods disclosed herein may be utilized in other types of wireless communication systems.

The term “simultaneous” may be used herein to denote a situation where two or more events occur in overlapping time frames. In other words, two “simultaneous” events may overlap in time to some extent, but are not necessarily of the same duration. Furthermore, simultaneous events may or may not begin or end at the same time.

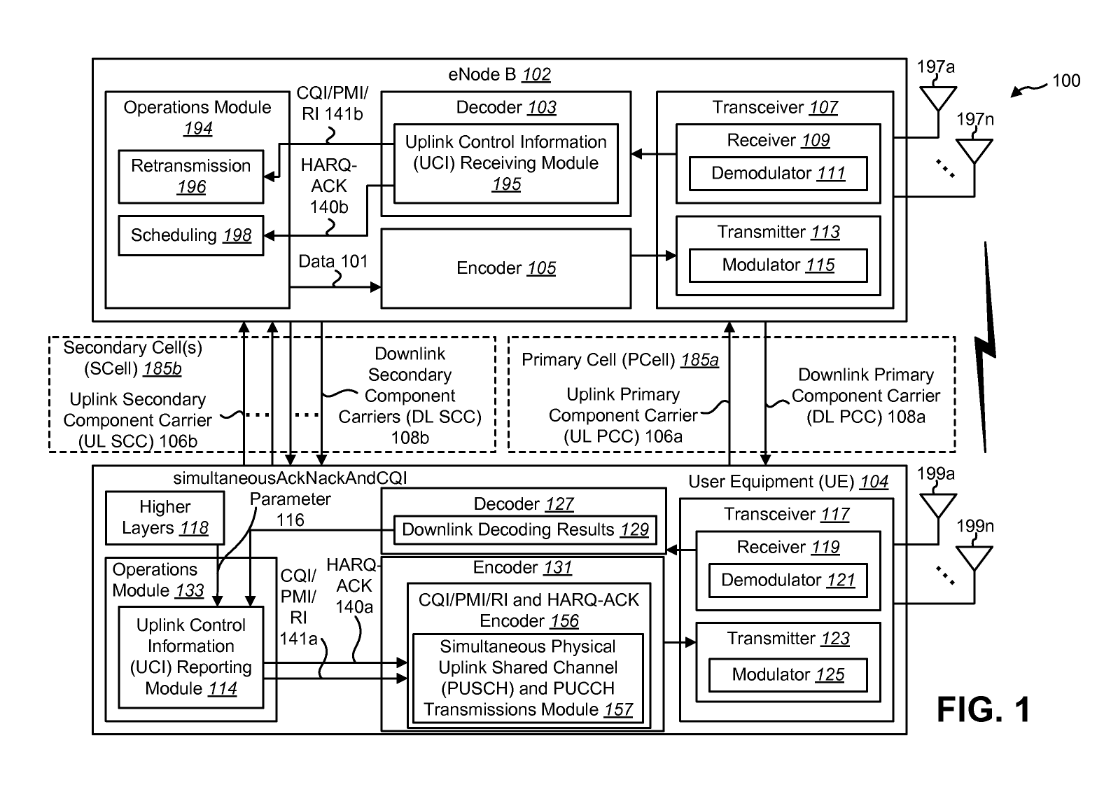

FIG. 1 is a block diagram illustrating a wireless communication system 100 using uplink control information (UCI) multiplexing. An eNode B 102 may be in wireless communication with one or more user equipments (UEs) 104. An eNode B 102 may be referred to as an access point, a Node B, a base station or some other terminology. Likewise, a user equipment (UE) 104 may be referred to as a mobile station, a subscriber station, an access terminal, a remote station, a user terminal, a terminal, a handset, a subscriber unit, a wireless communication device, or some other terminology.

Communication between a user equipment (UE) 104 and an eNode B 102 may be accomplished using transmissions over a wireless link, including an uplink and a downlink. The uplink refers to communications sent from a user equipment (UE) 104 to an eNode B 102. The downlink refers to communications sent from an eNode B 102 to a user equipment (UE) 104. The communication link may be established using a single-input and single-output (SISO), multiple-input and single-output (MISO), single-input and multiple-output (SIMO) or a multiple-input and multiple-output (MIMO) system. A MIMO system may include both a transmitter and a receiver equipped with multiple transmit and receive antennas. Thus, an eNode B 102 may have multiple antennas and a user equipment (UE) 104 may have multiple antennas. In this way, the eNode B 102 and the user equipment (UE) 104 may each operate as either a transmitter or a receiver in a MIMO system. One benefit of a MIMO system is improved performance if the additional dimensionalities created by the multiple transmit and receive antennas are utilized.

The user equipment (UE) 104 communicates with an eNode B 102 using one or more antennas 199a-n. The user equipment (UE) 104 may include a transceiver 117, a decoder 127, an encoder 131 and an operations module 133. The transceiver 117 may include a receiver 119 and a transmitter 123. The receiver 119 may receive signals from the eNode B 102 using one or more antennas 199a-n. For example, the receiver 119 may receive and demodulate received signals using a demodulator 121. The transmitter 123 may transmit signals to the eNode B 102 using one or more antennas 199a-n. For example, the transmitter 123 may modulate signals using a modulator 125 and transmit the modulated signals.

The receiver 119 may provide a demodulated signal to the decoder 127. The user equipment (UE) 104 may use the decoder 127 to decode signals and make downlink decoding results 129. The downlink decoding results 129 may indicate whether data was received correctly. For example, the downlink decoding results 129 may indicate whether a packet was correctly or erroneously received (i.e., positive acknowledgement, negative acknowledgement or discontinuous transmission (no signal)).

The operations module 133 may be a software and/or hardware module used to control user equipment (UE) 104 communications. For example, the operations module 133 may determine when the user equipment (UE) 104 requires resources to communicate with an eNode B 102.

In 3^{rd} Generation Partnership Project (3GPP) Long Term Evolution (LTE)-Advanced, additional control feedback will have to be sent on control channels to accommodate MIMO and carrier aggregation. Carrier aggregation refers to transmitting data on multiple component carriers (CC) that are contiguously or separately located. Both the hybrid automatic repeat and request (ARQ) acknowledgement (HARQ-ACK) with positive-acknowledge and negative-acknowledge (ACK/NACK) bits and other control information may be transmitted using the physical uplink control channel (PUCCH). In carrier aggregation (CA), only one uplink component carrier (CC) may be utilized for transmission of control information. In LTE-A, component carriers (CC) are referred to as cells.

The user equipment (UE) 104 may transmit uplink control information (UCI) to an eNode B 102 on the uplink. The uplink control information (UCI) may include a channel quality indicator (CQI), a precoding matrix indicator (PMI), rank indication (RI), a scheduling request (SR) and a hybrid automatic repeat request acknowledgement (HARQ-ACK) 140a. HARQ-ACK 140a means ACK (positive-acknowledgement) and/or NACK (negative-acknowledgement) and/or DTX (discontinuous transmission) responses for HARQ operation, also known as ACK/NACK. If a transmission is successful, the HARQ-ACK 140a may have a logical value of 1and if the transmission is unsuccessful, the HARQ-ACK 140a may have a logical value of 0.

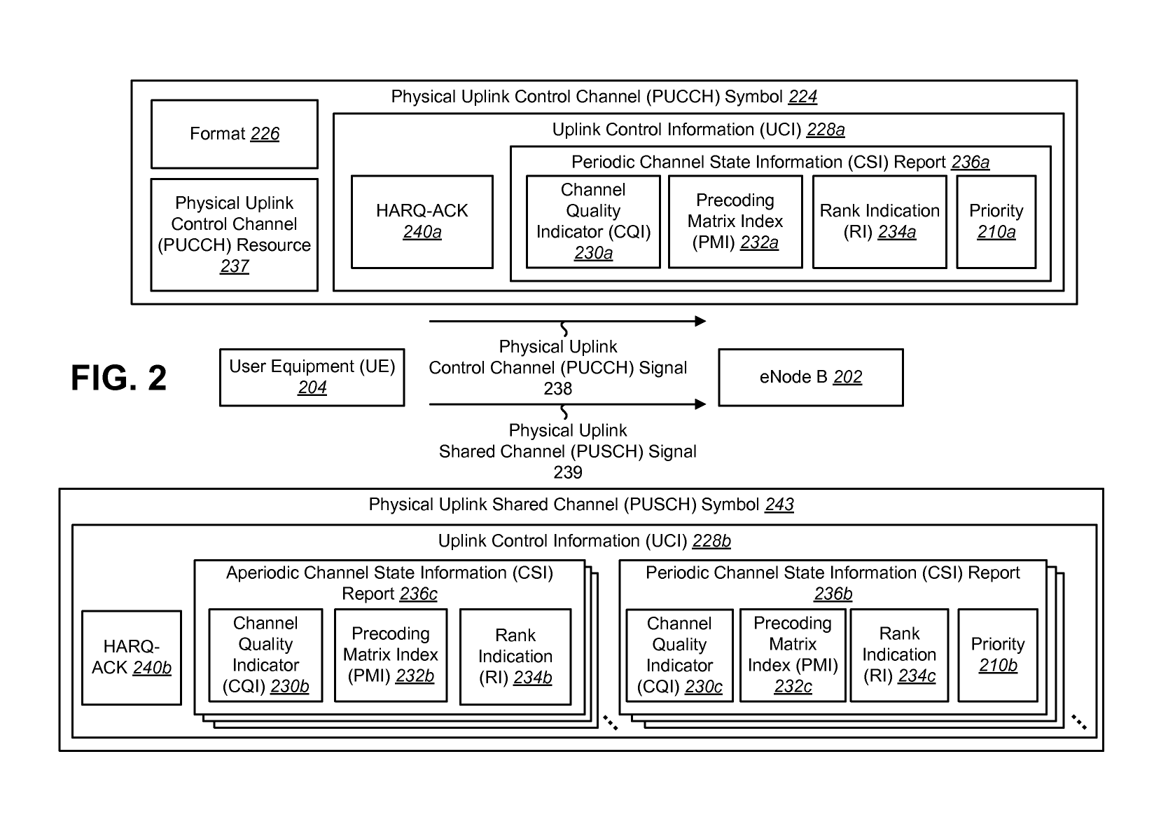

In one configuration, the CQI/PMI/RI 141a and the HARQ-ACK 140a may be separately coded. In another configuration, the CQI/PMI/RI 141a and the HARQ-ACK 140a may be jointly coded. Herein, CQI/PMI/RI 141 refers to CQI and/or PMI and/or RI. CQI/PMI/RI 141 may also be referred to as channel state information (CSI). The CQI and/or PMI and/or RI may be reported together or independently based on the physical uplink control channel (PUCCH) reporting modes. ACK/NACK refers to ACK and/or NACK. CQI/PMI/RI 141 and HARQ-ACK 140 refers to ((CQI and/or PMI and/or RI) AND HARQ-ACK 140). CQI/PMI/RI 141 or HARQ-ACK refers to ((CQI and/or PMI and/or RI) OR HARQ-ACK 140). The CQI/PMI/RI 141 may be collectively referred to as channel state information (CSI). A channel state information (CSI) report thus may include a CQI/PMI/RI 141 report. Channel state information (CSI) is discussed in additional detail below in relation to FIG. 2.

Channel state information (CSI) reporting from a user equipment (UE) 104 to an eNode B 102 may be periodic or aperiodic. Aperiodic channel state information (CSI) reports may be requested by an eNode B 102. Aperiodic channel state information (CSI) reports are not transmitted on the physical uplink control channel (PUCCH). Periodic channel state information (CSI) reports may be configured by an eNode B 102, so that a user equipment (UE) 104 reports channel state information (CSI) to the eNode B 102 at pre-specified subframes. When periodic channel state information (CSI) reports are scheduled for transmission, if only the physical uplink control channel (PUCCH) is available, one periodic channel state information (CSI) report may be transmitted on the physical uplink control channel (PUCCH). In Rel-8/9, simultaneous physical uplink shared channel (PUSCH) and physical uplink control channel (PUCCH) transmission is not allowed. Thus, if a physical uplink shared channel (PUSCH) is scheduled, one periodic channel state information (CSI) report may be multiplexed on the physical uplink shared channel (PUSCH). Aperiodic channel state information (CSI) reports are always transmitted on the physical uplink shared channel (PUSCH). Hence, there is a need for a distinction between periodic channel state information (CSI) reports and aperiodic channel state information (CSI) reports.

The CQI/PMI/RI 141a report and the HARQ-ACK 140a may be generated by the uplink control information (UCI) reporting module 114 and transferred to a CQI/PMI/RI and HARQ-ACK encoder 156 that is part of the encoder 131. The CQI/PMI/RI and HARQ-ACK encoder 156 may generate uplink control information (UCI) using backwards compatible physical uplink control channel (PUCCH) formats and physical uplink shared channel (PUSCH) formats. Backwards compatible physical uplink control channel (PUCCH) formats are those formats that may be used by Release-10 user equipments (UEs) 104 as well as Release-8/9 user equipments (UEs) 104.

The CQI/PMI/RI and HARQ-ACK encoder 156 may include a simultaneous physical uplink control channel (PUCCH) and physical uplink shared channel (PUSCH) transmissions module 157. In Release-8, a user equipment (UE) 104 does not simultaneously transmit on the physical uplink control channel (PUCCH) and the physical uplink shared channel (PUSCH). If the physical uplink shared channel (PUSCH) is available, no periodic channel state information (CSI) reports are transmitted on the physical uplink control channel (PUCCH). Aperiodic channel state information (CSI) reports are always transmitted on the physical uplink shared channel (PUSCH).

One resource of the physical uplink control channel (PUCCH) may be allocated for transmission of the uplink control information (UCI) with collision resolution procedures resolving any collision issues. In general, the resource allocated for the transmission of HARQ-ACK 140a is different from the resource allocated for the transmission of periodic channel state information (CSI) on the physical uplink control channel (PUCCH). If only one of the HARQ-ACK 140a and the periodic channel state information (CSI) is available for transmission, the corresponding resource is used for transmissions. In case of a collision in the schedule of the transmission of HARQ-ACK 140a and channel state information (CSI), a collision resolution procedure may be used to determine the resource and format used for transmission. If the physical uplink shared channel (PUSCH) is available, the aperiodic channel state information (CSI) reports may take priority over periodic channel state information (CSI) reports and be time and/or frequency shared with the HARQ-ACK 140.

In 3GPP LTE Release-10 (LTE-A or Advanced EUTRAN), simultaneous physical uplink shared channel (PUSCH) and physical uplink control channel (PUCCH) transmission is introduced and can be configured. A user equipment (UE) 104 may have several transmission modes including physical uplink control channel (PUCCH) only transmission (when no physical uplink shared channel (PUSCH) is scheduled), physical uplink shared channel (PUSCH) only transmission (when simultaneous physical uplink shared channel (PUSCH) and physical uplink control channel (PUCCH) transmission is not configured and a physical uplink shared channel (PUSCH) is scheduled) and simultaneous physical uplink shared channel (PUSCH) and physical uplink control channel (PUCCH) transmission when it is configured. If simultaneous physical uplink shared channel (PUSCH) and physical uplink control channel (PUCCH) transmission is configured, the physical uplink control channel (PUCCH) is assumed to always be available to send uplink control information (UCI). The physical uplink control channel (PUCCH) for CQI/PMI/RI may be semi-statically scheduled by an eNode B 102 but the physical uplink control channel (PUCCH) for ACK/NACK may be dynamically allocated based on downlink configurations and transmission.

A user equipment (UE) 104 that has multiple uplink control information (UCI) elements for transmission may experience a collision. Some collision resolution procedures have already been defined. For example, when an HARQ-ACK 140 and a channel state information (CSI) report collide, a simultaneousAckNackAndCQI parameter 116 may resolve the collision. The simultaneousAckNackAndCQI parameter 116 is discussed in additional detail below.

The use of simultaneous physical uplink shared channel (PUSCH) and physical uplink control channel (PUCCH) transmissions may be configured by a radio resource control (RRC) configuration based on user equipment (UE) 104 specific RRC signaling. When a user equipment (UE) 104 that is configured for simultaneous physical uplink shared channel (PUSCH) and physical uplink control channel (PUCCH) transmission is allocated or assigned both the physical uplink shared channel (PUSCH) and the physical uplink control channel (PUCCH) on a subframe or when the user equipment (UE) 104 is required to transmit on both the physical uplink shared channel (PUSCH) and the physical uplink control channel (PUCCH) on a subframe, the user equipment (UE) 104 may transmit on the physical uplink shared channel (PUSCH) and the physical uplink control channel (PUCCH) simultaneously.

The user equipment (UE) 104 may use the simultaneous physical uplink shared channel (PUSCH) and physical uplink control channel (PUCCH) transmissions module 157 to dynamically switch between simultaneous physical uplink shared channel (PUSCH) and physical uplink control channel (PUCCH) transmission and non-simultaneous physical uplink shared channel (PUSCH) and physical uplink control channel (PUCCH) transmission.

The user equipment (UE) 104 may also transmit a reference signal (RS) to an eNode B 102. The uplink control information (UCI) may be transmitted using the physical uplink control channel (PUCCH) and/or the physical uplink shared channel (PUSCH). One or more physical uplink control channel (PUCCH) reference signal (RS) symbols are included in a physical uplink control channel (PUCCH) signal transmission on each slot.

The time and frequency resources may be quantized to create a grid known as the Time-Frequency grid. In the time domain, 10 milliseconds (ms) is referred to as one radio frame. One radio frame may include 10 subframes, each with a duration of 1 ms which is the duration of transmission in the uplink and/or downlink. Every subframe may be divided into two slots, each with a duration of 0.5 ms. Each slot may be divided into 7 symbols. The frequency domain may be divided into bands with a 15 kilohertz (kHz) width referred to as a subcarrier. One resource element has a duration of one symbol in the time domain and the bandwidth of one subcarrier in the frequency domain.

The minimum amount of resource that can be allocated for the transmission of information in the uplink or downlink in any given subframe is two resource blocks (RBs), one RB at each slot. One RB has a duration of 0.5 ms (7 symbols or one slot) in the time domain and a bandwidth of 12 subcarriers (180 kHz) in the frequency domain. At any given subframe, a maximum of two RBs (one RB at each slot) can be used by a given user equipment (UE) 104 for the transmission of uplink control information (UCI) in the physical uplink control channel (PUCCH). However, the eNode B 102 may allocate different RBs for the transmission of HARQ-ACK 140a and periodic channel state information (CSI). In case of a collision, a collision resolution mechanism may decide which RB and what format are used for the transmission of both or one of the HARQ-ACK 140a and the periodic channel state information (CSI).

In LTE Release-8, only one uplink component carrier (CC) and one downlink component carrier (CC) can be used for transmission to and reception from each user equipment (UE) 104. The uplink control information (UCI) such as ACK/NACK bits for hybrid ARQ (HARQ) 140a and periodic channel quality indicators (CQI), periodic precoding matrix indicator (PMI) and periodic rank indication (RI) can be sent on the physical uplink control channel (PUCCH), on the physical uplink shared channel (PUSCH) or on both. In one configuration where simultaneous physical uplink shared channel (PUSCH) and physical uplink control channel (PUCCH) transmission is configured, there may be a first uplink control information (UCI) that is scheduled on the physical uplink control channel (PUCCH) and a second uplink control information (UCI) that is scheduled on the physical uplink shared channel (PUSCH). In some conditions, for example in cases when simultaneous physical uplink shared channel (PUSCH) and physical uplink control channel (PUCCH) transmission is not configured, the uplink control information (UCI) that is scheduled on the physical uplink control channel (PUCCH) may be transmitted on the physical uplink shared channel (PUSCH) if a physical uplink shared channel (PUSCH) is scheduled in the subframe.

The physical uplink control channel (PUCCH) may occupy one resource block (RB) at each slot. Thus, a very limited amount of information can be transmitted on the physical uplink control channel (PUCCH).

In 3GPP Long Term Evolution (LTE) Release-10 (LTE-A or Advanced EUTRAN), carrier aggregation was introduced. Carrier aggregation may also be referred to as cell aggregation. Carrier aggregation is supported in both the uplink and the downlink with up to five component carriers (CCs), also known as cells. Each component carrier (CC) or cell may have a transmission bandwidth of up to one hundred and ten resource blocks (i.e., up to 20 megahertz (MHz)). In carrier aggregation, two or more component carriers (CCs) or cells are aggregated to support wider transmission bandwidths up to 100 megahertz (MHz). A user equipment (UE) 104 may simultaneously receive and/or transmit on one or multiple component carriers (CCs) or cells, depending on the capabilities of the user equipment (UE) 104.

Based on current agreements, cyclic reporting of periodic CQI/PMI/RI 141 of each component carrier (CCs) is supported in Release-10. Thus, the same periodic CQI/PMI/RI payload as in Release-8 can be used. Therefore, a Format 2 based physical uplink control channel (PUCCH) may be reused for periodic CQI/PMI/RI 141 reporting of each component carrier (CC) or cell.

The uplink control information (UCI) generated by the uplink control information (UCI) reporting module 114 may be dependent on the simultaneousAckNackAndCQI parameter 116. For example, the format used for transmitting the uplink control information (UCI) may be dependent on the simultaneousAckNackAndCQI parameter 116. The simultaneousAckNackAndCQI parameter 116 may be provided by higher layers 118 (e.g., the radio resource control (RRC) layer) on the user equipment (UE) 104. The simultaneousAckNackAndCQI parameter 116 may be used by the user equipment (UE) 104 to determine whether to use periodic CQI/PMI/RI 141 dropping or simultaneous reporting of the periodic CQI/PMI/RI 141 and the HARQ-ACK 140. The choice of periodic CQI/PMI/RI 141 dropping or simultaneous reporting of the periodic CQI/PMI/RI 141 and the HARQ-ACK 140 may be configured by the eNode B 102. For example, simultaneous periodic CQI/PMI/RI 141 and HARQ-ACK 140 reporting should be used if the simultaneousAckNackAndCQI parameter 116 is set to TRUE. Otherwise, the periodic CQI/PMI/RI 141 should be dropped.

A user equipment (UE) 104 may communicate with an eNode B 102 using multiple cells 185 at the same time. For example, a user equipment (UE) 104 may communicate with an eNode B 102 using a primary cell (PCell) 185a while simultaneously communicating with the eNode B 102 using secondary cell(s) (SCell) 185b. Similarly, an eNode B 102 may communicate with a user equipment (UE) 104 using multiple cells 185 at the same time. For example, an eNode B 102 may communicate with a user equipment (UE) 104 using a primary cell (PCell) 185a while simultaneously communicating with the user equipment (UE) 104 using secondary cell(s) (SCell) 185b.

An eNode B 102 may include a transceiver 107 that includes a receiver 109 and a transmitter 113. An eNode B 102 may additionally include a decoder 103, an encoder 105 and an operations module 194. An eNode B 102 may receive uplink control information (UCI) using its one or more antennas 197a-n and its receiver 109. The receiver 109 may use the demodulator 111 to demodulate the uplink control information (UCI).

The decoder 103 may include an uplink control information (UCI) receiving module 195. An eNode B 102 may use the uplink control information (UCI) receiving module 195 to decode and interpret the uplink control information (UCI) received by the eNode B 102. The eNode B 102 may use the decoded uplink control information (UCI) to perform certain operations, such as retransmit one or more packets based on scheduled communication resources for the user equipment (UE) 104. The uplink control information (UCI) may include a CQI/PMI/RI 141b and/or an HARQ-ACK 140b.

The operations module 194 may include a retransmission module 196 and a scheduling module 198. The retransmission module 196 may determine which packets to retransmit (if any) based on the uplink control information (UCI). The scheduling module 198 may be used by the eNode B 102 to schedule communication resources (e.g., bandwidth, time slots, frequency channels, spatial channels, etc.). The scheduling module 198 may use the uplink control information (UCI) to determine whether (and when) to schedule communication resources for the user equipment (UE) 104.

The operations module 194 may provide data 101 to the encoder 105. For example, the data 101 may include packets for retransmission and/or a scheduling grant for the user equipment (UE) 104. The encoder 105 may encode the data 101, which may then be provided to the transmitter 113. The transmitter 113 may modulate the encoded data using the modulator 115. The transmitter 113 may transmit the modulated data to the user equipment (UE) 104 using one or more antennas 197a-n.

When carrier aggregation is configured, a user equipment (UE) 104 may have only one Radio Resource Control (RRC) connection with the network. At the RRC connection establishment/re-establishment/handover, one serving cell (i.e., the primary cell (PCell) 185a) provides the non-access stratum (NAS) mobility information (e.g., Tracking Area Identity (TAI)) and the security input.

In the downlink, the carrier corresponding to the primary cell (PCell) 185a is the downlink primary component carrier (DL PCC) 108a. In the uplink, the carrier corresponding to the primary cell (PCell) 185a is the uplink primary component carrier (UL PCC) 106a. Depending on the capabilities of the user equipment (UE) 104, one or more secondary component carriers (SCC) or secondary cells (SCell) 185b may be configured to form a set of serving cells with the primary cell (PCell) 185a. In the downlink, the carrier corresponding to the secondary cell (SCell) 185b is the downlink secondary component carrier (DL SCC) 108b. In the uplink, the carrier corresponding to the secondary cell (SCell) 185b is the uplink secondary component carrier (UL SCC) 106b. The number of downlink component carriers (CCs) 108 may be different from the number of uplink component carriers (CCs) 106 because multiple cells may share one uplink component carrier (CC) 106.

If carrier aggregation is configured, a user equipment (UE) 104 may have multiple serving cells: a primary cell (PCell) 185a and one or more secondary cells (SCell) 185b. From a network perspective, the same serving cell may be used as the primary cell (PCell) 185a by one user equipment (UE) 104 and used as a secondary cell (SCell) 185b by another user equipment (UE) 104. A primary cell (PCell) 185a that is operating according to Release-8/9 is equivalent to the Release-8/9 serving cell. When operating according to Release-10, there may be one or more secondary cells (SCell) 185b in addition to the primary cell (PCell) 185a if carrier aggregation is configured.

A number of spatial channels may be available on each serving cell by using multiple antennas at a transmitter and a receiver. Therefore, multiple codewords (up to two codewords) may be transmitted simultaneously. If the user equipment (UE) 104 is configured with five component carriers (CCs) (cells) and two codewords for each of the component carriers (CCs) (cells), ten HARQ-ACK 140 acknowledgement/negative acknowledgement (ACK/NACK) bits for a single downlink subframe may be generated by the user equipment (UE) 104. One benefit of using carrier aggregation is that additional downlink and/or uplink data may be transmitted. As a result of the additional downlink data, additional uplink control information (UCI) may be needed.

It has been agreed that for periodic CQI/PMI/RI 141 reporting for carrier aggregation, the configuration of different (in time) physical uplink control channel (PUCCH) resources for reports for each component carrier (CC) is supported.

FIG. 2 is a block diagram illustrating transmissions from a user equipment (UE) 204 to an eNode B 202 during a subframe. The user equipment (UE) 204 may transmit a physical uplink control channel (PUCCH) symbol 224 via a physical uplink control channel (PUCCH) symbol 238 to the eNode B 202. The user equipment (UE) 204 may also transmit a physical uplink shared channel (PUSCH) symbol 243 via a physical uplink shared channel (PUSCH) signal 239 to the eNode B 202. In one configuration, the user equipment (UE) 204 may simultaneously transmit a physical uplink control channel (PUCCH) symbol 224 and a physical uplink shared channel (PUSCH) symbol 243 to the eNode B 202.

Simultaneous transmission on the physical uplink control channel (PUCCH) and the physical uplink shared channel (PUSCH) is introduced and configurable in Release-10. In Release-8 and Release-9, simultaneous transmission on the physical uplink control channel (PUCCH) and the physical uplink shared channel (PUSCH) is not allowed. Thus, all references to simultaneous transmission on the physical uplink control channel (PUCCH) and the physical uplink shared channel (PUSCH) are related to Release-10, and not to Release-8 or Release-9.

The physical uplink control channel (PUCCH) symbol 224 may include uplink control information (UCI) 228a. The uplink control information (UCI) 228a may include an HARQ-ACK 240a. The uplink control information (UCI) 228a may also include a periodic channel state information (CSI) report 236a. A channel state information (CSI) report 236 refers to the channel state information (CSI) of each of the downlink component carriers (CC) 108. The periodic channel state information (CSI) report 236a may include a channel quality indicator (CQI) 230a, a precoding matrix indicator (PMI) 232a, and/or a rank indication (RI) 234a. When a user equipment (UE) 204 has data to be transmitted and no physical uplink shared channel (PUSCH) is assigned, the user equipment (UE) 204 may generate a scheduling request (SR). When a physical uplink shared channel (PUSCH) symbol 243 is already scheduled for transmission, the user equipment (UE) 204 does not generate a scheduling request (SR). Thus, the uplink control information (UCI) 228a may include a scheduling request (SR) but the scheduling request (SR) is not a part of channel state information (CSI).

The periodic channel state information (CSI) report 236a may also include a priority 210a. When simultaneous physical uplink control channel (PUCCH) and physical uplink shared channel (PUSCH) transmission is enabled, the HARQ-ACK 240a or the periodic channel state information (CSI) report 236a with the highest priority 210a may be carried on the physical uplink control channel (PUCCH) while the remaining periodic channel state information (CSI) reports 236b are carried on the physical uplink shared channel (PUSCH) (or dropped). The priority of different types of uplink control information (UCI) 228 may be provided by the eNode B 202 or by predefined rules. For example, if an HARQ-ACK 240 and one or more channel state information (CSI) reports 236 needs to be transmitted in a subframe, the most important uplink control information (UCI) 228 (the HARQ-ACK 240 in this case) may be transmitted on the physical uplink control channel (PUCCH) and the dropped channel state information (CSI) reports 236 from the physical uplink control channel (PUCCH) may be carried on the physical uplink shared channel (PUSCH).

In Rel-8/9, only one component carrier (CC) is allocated for a user equipment (UE). Thus, only one periodic channel state information (CSI) report 236a-b is generated (i.e., CQI and/or PMI and/or RI for one component carrier (CC) is reported). For aperiodic channel state information (CSI) reports 236c, the rank indication (RI) is transmitted only if the configured CQI/PMI/RI feedback type supports rank indication (RI) reporting. In cases where both a periodic channel state information (CSI) report 236a-b and an aperiodic channel state information (CSI) report 236c would occur in the same subframe, the user equipment (UE) 204 would only transmit the aperiodic channel state information (CSI) report 236c for that subframe.

In Rel-10 and beyond, multiple component carriers (CCs) or cells may be configured for a user equipment (UE) 204. Thus, multiple periodic channel state information (CSI) reports 236a-b corresponding to multiple component carriers (CCs) may collide in the same subframe (i.e., the multiple periodic channel state information (CSI) reports 236a-b may have schedules that would force them to be transmitted in the same subframe). Because the periodic channel state information (CSI) reports 236a-b may include valuable control information that is not included in an aperiodic channel state information (CSI) report 236c, it may be beneficial to not drop the periodic channel state information (CSI) reports 236a-b. Therefore, if configured, transmitting both aperiodic channel state information (CSI) reports 236c and periodic channel state information (CSI) reports 236b on the physical uplink shared channel (PUSCH) may provide system performance benefits.

The CQI/PMI/RI 141 of each component carrier (CC) or cell may be scheduled on the physical uplink control channel (PUCCH) periodically by higher layer 118 signaling (the CQI/PMI/RI 141 is periodic CQI/PMI/RI 141). The eNode B 202 may request periodic channel state information (CSI) 236a-b and aperiodic channel state information (CSI) 236c; the periodic channel state information (CSI) 236a-b may have a periodic reporting schedule while the aperiodic channel state information (CSI) 236c is generated dynamically and not configured by a periodic schedule. The eNode B 102 may also request transmission of CQI/PMI/RI 141. Such a request may be made through the physical downlink control channel (PDCCH) and the CQI/PMI/RI reported in response to such a request may be referred to as aperiodic CQI/PMI/RI 141. The physical uplink control channel (PUCCH) symbol 224 may be sent only on the primary cell (PCell) 185a. The HARQ-ACK 240a is generated dynamically based on the detection of a physical downlink shared channel (PDSCH). A collision may occur between the schedule for transmission of a periodic CQI/PMI/RI 141 and an HARQ-ACK 240a in the same subframe.

The physical uplink control channel (PUCCH) symbol 224 may further include a format 226 for which the physical uplink control channel (PUCCH) symbol 224 is transmitted. For example, the physical uplink control channel (PUCCH) symbol 224 may be transmitted using Format 1/1a/1b, Format 2/2a/2b, Format 3/3a/3b or any other new formats. As used herein, Format 1/1a/1b represents Format 1 and/or Format 1a and/or Format 1b. Also, as used herein, Format 2/2a/2b represents Format 2 and/or Format 2a and/or Format 2b. Herein, Format 3/3a/3b represents Format 3 and/or Format 3a and/or Format 3b.

Format 3a/3b is not currently defined in the 3GPP specification. Format 3a and 3b are analogues to Format 2a and 2b as defined by 3GPP. In a subframe with Format 3a, additional control information may be carried on one of the two reference signals of the subframe using Binary Phase Shift Keying (BPSK) modulation. In a subframe with Format 3b, additional control information may be carried on one of the two reference signals of the subframe using Quadrature Phase Shift Keying (QPSK) modulation.

The physical uplink control channel (PUCCH) symbol 224 may also include a physical uplink control channel (PUCCH) resource 237. The physical uplink control channel (PUCCH) resource 237 for the periodic CQI/PMI/RI 141 may be periodically pre-assigned by a higher layer 118, which uses Format 2/2a/2b. The eNode B 202 may dynamically allocate the physical downlink shared channel (PDSCH); the HARQ-ACK 240a is then dynamically generated in a subframe. Therefore, sometimes the periodic CQI/PMI/RI 141 may collide with the HARQ-ACK 240a in the same subframe.

To avoid dropping one of them in collisions between a periodic CQI/PMI/RI 141 and an HARQ-ACK 240a, the periodic CQI/PMI/RI 141 may be multiplexed with the HARQ-ACK 240a on the physical uplink control channel (PUCCH). This is because of the single carrier property for uplink in an LTE system (i.e., a user equipment (UE) 204 should not transmit multiple physical uplink control channels (PUCCHs) simultaneously on one component carrier (CC)). Format 3 may be used for multiplexing the periodic CQI/PMI/RI 141 with the HARQ-ACK 240a. If the periodic CQI/PMI/RI 141 and the HARQ-ACK 240a are not multiplexed, the periodic CQI/PMI/RI 141 may be dropped by the user equipment (UE) 204. Thus, one benefit of using Format 3 is that the CQI/PMI/RI 141 may be multiplexed with the HARQ-ACK 240a, allowing for the uplink transmission of additional data.

A user equipment (UE) 204 that supports up to four ACK/NACK bits can use physical uplink control channel (PUCCH) Format 1a/1b with channel selection for transmission of the HARQ-ACK 240a. A user equipment (UE) 204 that supports more than four ACK/NACK bits is configured by higher layer 118 signaling to use either physical uplink control channel (PUCCH) Format 1a/1b with channel selection or physical uplink control channel (PUCCH) Format 3 for transmission of the HARQ-ACK 240a. A user equipment (UE) 204 may determine the number of HARQ-ACK 240a bits based on the number of configured serving cells and the downlink transmission modes configured for each serving cell. A user equipment (UE) 204 may use two HARQ-ACK 240a bits for a serving cell configured with a downlink transmission mode that supports up to two transport blocks (codewords) and one HARQ-ACK 240a bit otherwise.

For physical uplink control channel (PUCCH) Format 3, a user equipment (UE) 204 may transmit a NACK for a DTX HARQ-ACK 240a response for a transport block (codeword) associated with a configured serving cell. DTX means that the user equipment (UE) 204 has missed the downlink assignment.

The physical uplink shared channel (PUSCH) symbol 243 may also include uplink control information (UCI) 228b. The uplink control information (UCI) 228b may include the ACK/NACK information corresponding to the transmission of data in the downlink (such as an HARQ-ACK 240b), one or more aperiodic channel state information (CSI) reports 236c and one or more periodic channel state information (CSI) reports 236b. The number of aperiodic channel state information (CSI) reports 236c and the number of periodic channel state information (CSI) reports 236b may be signaled by the eNode B 202 via radio resource control (RRC) signaling.

An eNode B 202 may trigger aperiodic channel state information (CSI) reporting on the physical uplink shared channel (PUSCH) in an on-demand basis. An aperiodic channel state information (CSI) report 236c may collide with one or more periodic channel state information (CSI) reports 236a-b. A collision refers to a subframe where both an aperiodic channel state information (CSI) report 236c is triggered and one or more periodic channel state information (CSI) reports 236a-b are scheduled. Unlike in Rel-8, the aperiodic channel state information (CSI) report 236c in Rel-10 may have channel state information (CSI) for more than one component carrier (CC). The aperiodic channel state information (CSI) report 236c may include channel state information (CSI) for different component carriers (CCs) than the periodic channel state information (CSI) reports 236a-b.

Each aperiodic channel state information (CSI) report 236c may include channel state information (CSI) for one or more component carriers (CCs). An aperiodic channel state information (CSI) report 236c may include channel state information (CSI) for different component carriers (CCs) from the periodic channel state information (CSI) reports 236a-b. In one configuration, an aperiodic channel state information (CSI) report 236c may include channel state information (CSI) for only one component carrier (CC). In another configuration, an aperiodic channel state information (CSI) report 236c may include channel state information (CSI) for multiple component carriers (CCs). In yet another configuration, an aperiodic channel state information (CSI) report 236c may be a combination of multiple aperiodic channel state information (CSI) reports 236c, each corresponding to one or more component carriers (CCs).

If the aperiodic channel state information (CSI) report 236c and the periodic channel state information (CSI) reports 236a-b are for different component carriers (CCs), it may be beneficial to not drop the periodic channel state information (CSI) reports 236a-b. Dropping periodic channel state information (CSI) reports 236a-b of one component carrier (CC) may cause a bad channel estimation of the component carrier (CC).

An aperiodic channel state information (CSI) report 236c may include one or more channel quality indicators (CQIs) 230b and/or one or more precoding matrix indicators (PMIS) 232b and/or one or more rank indications (RIs) 234b of one or more component carriers (CCs) or cells. The channel quality indicator (CQI) 230 may be a wideband channel quality indicator (CQI) 230, a subband channel quality indicator (CQI) 230 or a user equipment (UE) 104 selected subband channel quality indicator (CQI) 230. An aperiodic channel state information (CSI) report 236c is always transmitted on the physical uplink shared channel (PUSCH) symbol 243. A periodic channel state information (CSI) report 236b may also include a channel quality indicator (CQI) 230c and/or a precoding matrix indicator (PMI) 232c and/or a rank indication (RI) 234c and a priority 210b. The physical uplink shared channel (PUSCH) symbol 243 may be sent on the primary cell (PCell) 185a and/or on one or more secondary cells (SCell) 185b. The HARQ-ACK 240 is generated dynamically based on the detection of a physical downlink shared channel (PDSCH).

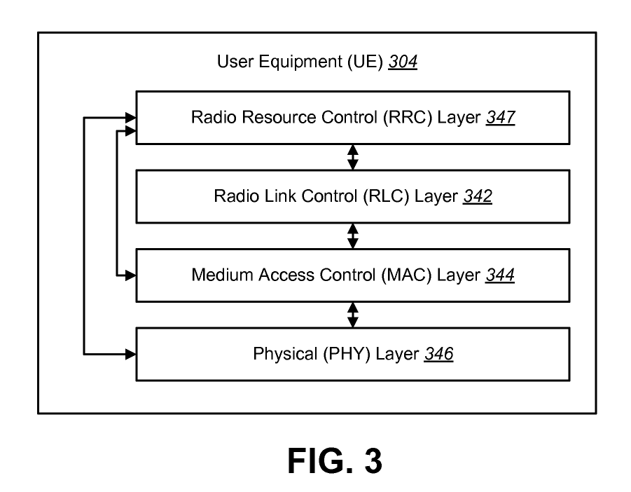

FIG. 3 is a block diagram illustrating the layers used by a user equipment (UE) 304. The user equipment (UE) 304 of FIG. 3 may be one configuration of the user equipment (UE) 104 of FIG. 1. The user equipment (UE) 304 may include a radio resource control (RRC) layer 347, a radio link control (RLC) layer 342, a medium access control (MAC) layer 344 and a physical (PHY) layer 346. These layers may be referred to as higher layers 118. The user equipment (UE) 304 may include additional layers not shown in FIG. 3.

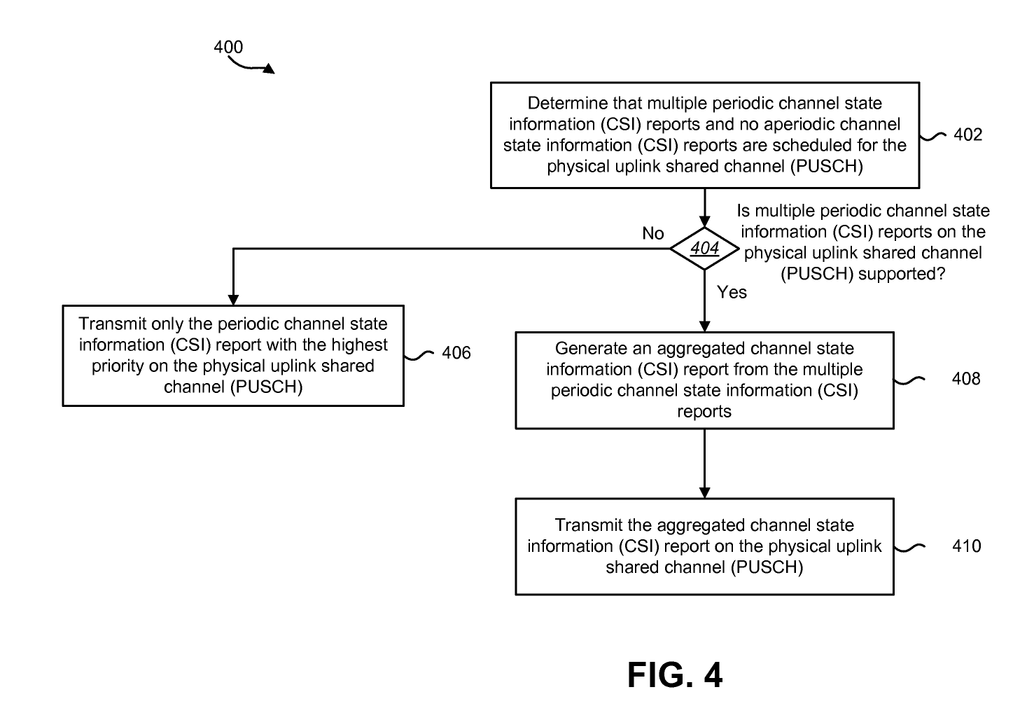

FIG. 4 is a flow diagram of a method 400 for transmitting periodic channel state information (CSI) reports 236a-b on the physical uplink shared channel (PUSCH). The method 400 may be performed by a user equipment (UE) 104. The user equipment (UE) 104 may determine 402 that multiple periodic channel state information (CSI) reports 236b and no aperiodic channel state information (CSI) reports 236c are scheduled for the physical uplink shared channel (PUSCH). As discussed above, periodic channel state information (CSI) reports 236b may be generated by a user equipment (UE) 104 at pre-specified subframes while aperiodic channel state information (CSI) reports 236c are generated in response to a request by an eNode B 102.

The user equipment (UE) 104 may determine 404 whether multiple periodic channel state information (CSI) reports 236b on the physical uplink shared channel (PUSCH) is supported. In Rel-10 and beyond, more than one component carrier (CC) (also referred to herein as a serving cell 185) may be configured by the radio resource control (RRC) for a user equipment (UE) 104. A component carrier (CC) may be activated or deactivated by the medium access control (MAC) layer 344. A periodic channel state information (CSI) report 236b may be generated for each component carrier (CC).

The periodic channel state information (CSI) reporting for each component carrier (CC) may be configured independently. Thus, multiple periodic channel state information (CSI) reporting schedules may collide in a subframe. If there is no physical uplink shared channel (PUSCH) scheduled in the subframe, a periodic channel state information (CSI) report 236a may be transmitted on the physical uplink control channel (PUCCH). Due to the limited capacity of the physical uplink control channel (PUCCH), only one periodic channel state information (CSI) report 236a may be transmitted on the physical uplink control channel (PUCCH) during a subframe; the other periodic channel state information (CSI) reports 236b may be dropped. Each periodic channel state information (CSI) report 236a-b may have a priority 210a-b that is provided by the eNode B 102 or by predefined rules.

If the physical uplink shared channel (PUSCH) is scheduled, a periodic channel state information (CSI) report 236b may be multiplexed onto the physical uplink shared channel (PUSCH). It has been agreed that only one uplink physical uplink shared channel (PUSCH) should be used for uplink control information (UCI) 228 reporting, even though multiple uplink physical uplink shared channels (PUSCHs) might be scheduled for transmission. The simplest method is for the user equipment (UE) 104 to transmit only one periodic channel state information (CSI) report 236b on the physical uplink shared channel (PUSCH) and drop the others. However, periodic channel state information (CSI) reports 236b are important control messages and dropping them may cause bad channel estimation and degrade the system performance. Therefore, if configured, multiplexing multiple periodic channel state information (CSI) reports 236b on the physical uplink shared channel (PUSCH) may provide system performance benefits.

If simultaneous transmission of the physical uplink control channel (PUCCH) and the physical uplink shared channel (PUSCH) is supported, and if no HARQ-ACK 240 is to be transmitted but multiple periodic channel state information (CSI) reports 236b are scheduled in a subframe, the periodic channel state information (CSI) report 236a with the highest priority 210a may be transmitted on the physical uplink control channel (PUCCH). The dropped periodic channel state information (CSI) reports 236b from the physical uplink control channel (PUCCH) may be carried on the physical uplink shared channel (PUSCH). If multiple periodic channel state information (CSI) reports 236b remain to be transmitted, multiple periodic channel state information (CSI) reports 236b on the physical uplink shared channel (PUSCH) transmission should be supported to multiplex the multiple periodic channel state information (CSI) reports 236b on the physical uplink shared channel (PUSCH).

Periodic channel state information (CSI) reporting is normally on a semi-statically allocated physical uplink control channel (PUCCH) resource. The payload size and the type of the channel state information (CSI) to be reported are decided by the physical uplink control channel (PUCCH) report type and reporting mode. In Rel-8/9, if a physical uplink shared channel (PUSCH) is scheduled in a subframe, the periodic channel state information (CSI) report 236b is multiplexed on the physical uplink shared channel (PUSCH). However, only one channel state information (CSI) report 236 (periodic or aperiodic) can be multiplexed on the physical uplink shared channel (PUSCH). In cases where both a periodic channel state information (CSI) report 236a-b and an aperiodic channel state information (CSI) report 236c occur in the same subframe, the user equipment (UE) 104 only transmits the aperiodic channel state information (CSI) report 236c in that subframe.

In Rel-10, each component carrier (CC) can be configured independently for periodic channel state information (CSI) reporting. Thus, transmission times of multiple periodic channel state information (CSI) reports 236a-b may collide in the same subframe. With the physical uplink control channel (PUCCH), only one periodic channel state information (CSI) report 236a can be reported. Thus, the periodic channel state information (CSI) report 236a with the highest priority 210a is reported and the other periodic channel state information (CSI) reports 236b are dropped.

If a physical uplink shared channel (PUSCH) is scheduled and simultaneous physical uplink control channel (PUCCH) and physical uplink shared channel (PUSCH) transmission is not allowed, the periodic channel state information (CSI) report 236b may be transmitted on the physical uplink shared channel (PUSCH). If a physical uplink shared channel (PUSCH) is scheduled and simultaneous physical uplink control channel (PUCCH) and physical uplink shared channel (PUSCH) transmission is allowed, the most important uplink control information (UCI) 228 (e.g., the HARQ-ACK 240 or the periodic channel state information (CSI) report 236a with the highest priority 210a when there is no HARQ-ACK 240) may be transmitted on the physical uplink control channel (PUCCH) and the dropped periodic channel state information (CSI) reports 236b may be transmitted on the physical uplink shared channel (PUSCH).

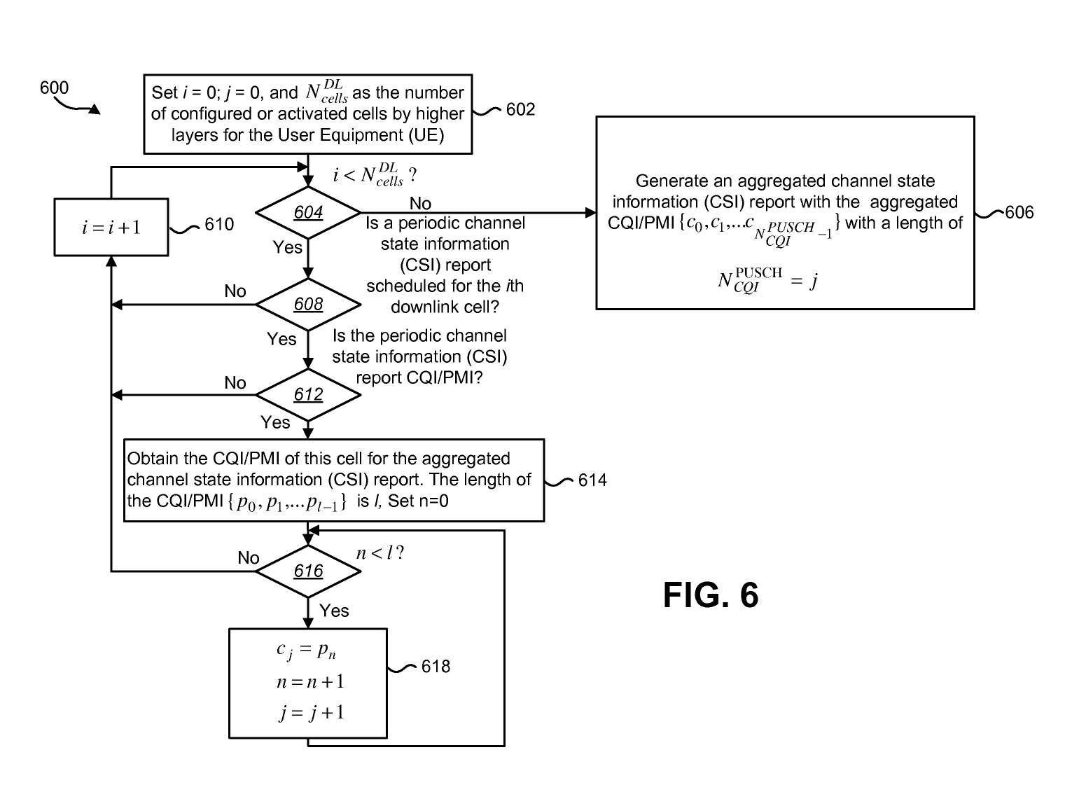

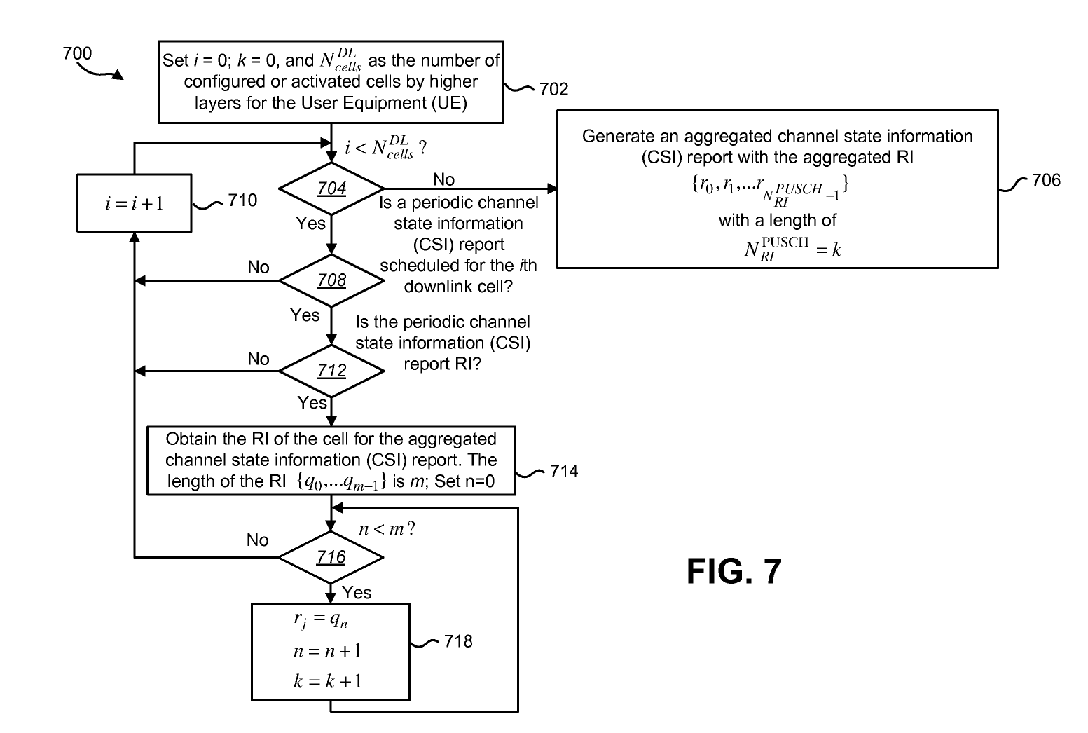

If multiple periodic channel state information (CSI) reports 236b on the physical uplink shared channel (PUSCH) is not supported, the user equipment (UE) 104 may transmit 406 only the periodic channel state information (CSI) report 236b with the highest priority 210b on the physical uplink shared channel (PUSCH). Other periodic channel state information (CSI) reports 236b may be dropped. If multiple periodic channel state information (CSI) reports 236b on the physical uplink shared channel (PUSCH) is supported, the user equipment (UE) 104 may generate 408 an aggregated channel state information (CSI) report from the multiple periodic channel state information (CSI) reports 236b. The user equipment (UE) 104 may then transmit 410 the aggregated channel state information (CSI) report on the physical uplink shared channel (PUSCH). An aggregated channel state information (CSI) report may include multiple periodic channel state information (CSI) reports 236b that are concatenated with component carrier (CC) ordering for each type of channel state information (CSI). The channel state information (CSI) may be split into two types, the CQI/PMI channel state information (CSI) and the rank indication (RI) channel state information (CSI). Aggregated channel state information (CSI) reports are discussed in additional detail below in relation to FIG. 6 and FIG. 7.

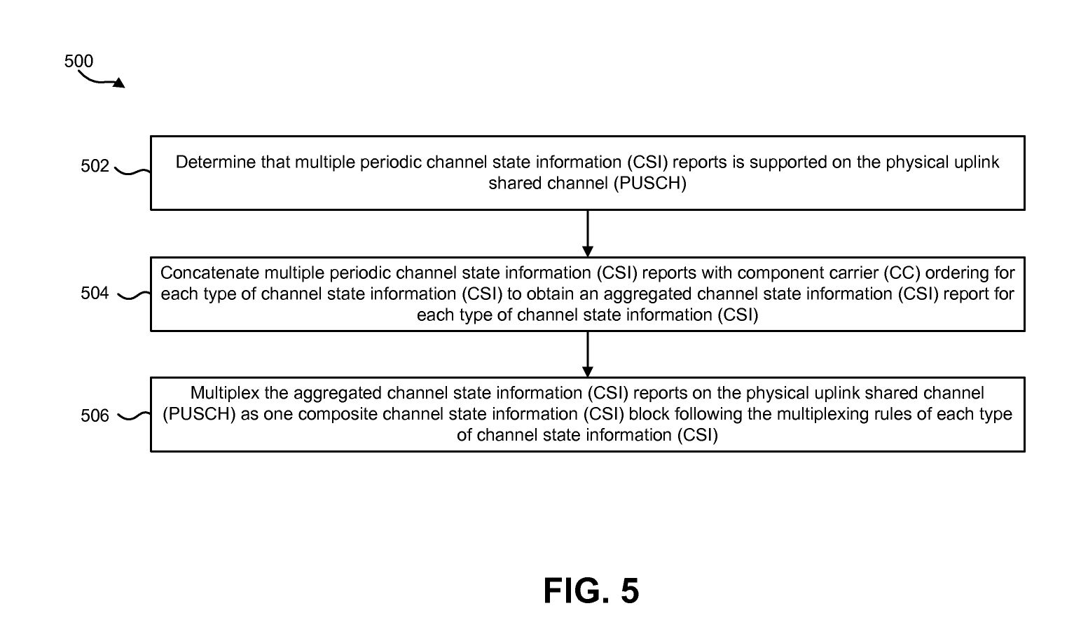

FIG. 5 is a flow diagram of a method 500 for transmitting multiple periodic channel state information (CSI) reports 236b on the physical uplink shared channel (PUSCH). The method 500 may be performed by a user equipment (UE) 104. The user equipment (UE) 104 may determine 502 that multiple periodic channel state information (CSI) reports 236b is supported on the physical uplink shared channel (PUSCH). The user equipment (UE) 104 may then concatenate 504 multiple channel state information (CSI) reports 236b with component carrier (CC) ordering for each type of channel state information (CSI) to obtain an aggregated channel state information (CSI) report for each type of channel state information (CSI). The user equipment (UE) 104 may multiplex 506 the aggregated channel state information (CSI) reports on the physical uplink shared channel (PUSCH) as one composite channel state information (CSI) block, following the multiplexing rules of each type of channel state information (CSI).

A periodic channel state information (CSI) report 236 of a component carrier (CC) or cell may be a CQI/PMI report or an RI report, but not both. An aggregated channel state information (CSI) report may be generated from multiple periodic channel state information (CSI) reports 236 in the same subframe. Only one aggregated channel state information (CSI) report is generated in a subframe. An aggregated channel state information (CSI) report may include an aggregated CQI/PMI and/or an aggregated RI. If some CSI reports are CQI/PMI and some are RI, the aggregated CSI report may contain both an aggregated CQI/PMI and an aggregated RI.

FIG. 6 is a flow diagram of a method 600 for concatenating multiple periodic channel state information (CSI) reports 236b that are CQI/PMI to obtain an aggregated CQI/PMI of an aggregated channel state information (CSI) report. The method 600 may be performed by a user equipment (UE) 104. If the periodic channel state information (CSI) reports 236b are CQI/PMI of the corresponding component carriers (CCs), the CQI/PMI {p₀, p₁, . . . pₗ₋₁} of each periodic channel state information (CSI) report 236b may be concatenated to form an aggregated CQI/PMI {c₀,c₁, . . . c_{N}_{_{CQI}}_{^{PUSCH}}₋₁} of the aggregated periodic channel state information (CSI), where N_{CQI}^{PUSCH} the payload size of the aggregated CQI/PMI of the aggregated channel state information (CSI) report and where l is the length of the CQI/PMI in a periodic channel state information (CSI) report 236a-b of a component carrier (CC), as decided by the physical uplink control channel (PUCCH) report type and reporting mode.

The user equipment (UE) 104 may set 602 the cell index i=0. Lower indices correspond to lower RRC indices of the corresponding cell. The user equipment (UE) 104 may also set the CQI/PMI bit index j=0. The user equipment (UE) 104 may further set N_{cells}^{DL} as the number of configured or activated cells by higher layers for the user equipment (UE) 104. The user equipment (UE) 104 may determine 604 whether i<N_{cells}^{DL}. If i<N_{cells}^{DL}, the user equipment (UE) 104 may determine 608 if a periodic channel state information (CSI) report 236a-b is scheduled for the i^{th} downlink cell. If a periodic channel state information (CSI) report 236a-b is not scheduled for the i^{th} downlink cell, the user equipment (UE) 104 may increment 610 i=i+1.

If a periodic channel state information (CSI) report 236a-b is scheduled for the i^{th} downlink cell, the user equipment (UE) 104 may determine 612 whether the periodic channel state information (CSI) report 236a-b is CQI/PMI. If the periodic channel state information (CSI) report 236a-b is not CQI/PMI, the user equipment (UE) 104 may increment 610 i=i+1. If the periodic channel state information (CSI) report 236a-b is CQI/PMI, the user equipment (UE) 104 may obtain 614 the CQI/PMI of the cell for the aggregated channel state information (CSI) report. The length of the CQI/PMI report {p₀, p₁, . . . pₗ₋₁} is l. The user equipment (UE) 104 may set n=0. While n</ 616, the user equipment (UE) 104 may set 618 the bit cⱼ of the aggregated CQI/PMI equal to the bit pₙ of the periodic channel state information (CSI), n=n+1 and j=j+1. Once n=l, the user equipment (UE) 104 may increment 610 i=i+1.

After the user equipment (UE) 104 has incremented 610 i=i+1, the user equipment (UE) 104 may again determine 604 whether i<N_{cells}^{DL}. If i=N_{cells}^{DL}, the user equipment (UE) 104 may generate 606 an aggregated channel state information (CSI) report with the aggregated CQI/PMI bits {c₀,c₁, . . . c_{N}_{_{CQI}}_{^{PUSCH}}₋₁} with a length of N_{CQI}^{PUSCH}=j.

Further payload optimization may be applied on the aggregated CQI/PMI to reduce the payload size. A periodic channel state information (CSI) report 236b may be a CQI/PMI report or a rank indication (RI) report, but not both. The aggregated channel state information (CSI) report may include an aggregated CQI/PMI and/or an aggregated rank indication (RI). If some of the periodic channel state information (CSI) reports 236b are CQI/PMI and some are rank indication (RI), the aggregated channel state information (CSI) report may include both an aggregated CQI/PMI and an aggregated rank indication (RI). The reason the CQI/PMI process and the rank indication (RI) process are separated is because each is multiplexed differently on the physical uplink shared channel (PUSCH) and have to be treated separately.

For example, the first CQI/PMI with the lowest cell index that has a CQI/PMI report may be concatenated with a full CQI/PMI report and the others may be coded with different channel quality indicator (CQI) feedback between the first CQI/PMI. Furthermore, not all CQI/PMI or rank indication (RI) may be transmitted in the same subframe. Depending on the priority, some less important information may be dropped.

If there are multiple physical uplink shared channels (PUSCHs) scheduled for a user equipment (UE) 104, only one physical uplink shared channel (PUSCH) should be selected to carry the uplink control information (UCI) 228. The aggregated CQI/PMI may be multiplexed onto the selected physical uplink shared channel (PUSCH). If the selected physical uplink shared channel (PUSCH) is configured with single-user multiple-input and multiple-output (SU-MIMO) with multiple codewords and layers, only one codeword may be selected to carry the aggregated CQI/PMI. The symbol length of the aggregated rank indication (RI) multiplexing may be calculated using the total aggregated CQI/PMI payload size N_{CQI}^{PUSCH}. The aggregated CQI/PMI may be coded with a Reed-Muller code (if the payload is≦11 bits) or a tail biting convolutional code (if the payload>11 bits), and then rate matched to the desired length. The rate matched output may become the coded CQI/PMI. The coded CQI/PMI may be multiplexed on all layers of the selected codeword. The aggregated CQI/PMI refers to raw information bits.

The CQI/PMI may be measured at the user equipment (UE) 104 and is measured as an integer number. In order to feedback these integer numbers, a binary representation may be generated. The binary representation of the measured CQI/PMI is referred to as ‘raw’ information bits. To achieve a level of reliability in transmission, the raw information bits may need to be channel coded. The process of channel coding includes the addition of parities and redundancies that take place in a channel encoder module. The output of the channel encoder module (when the input is raw CQI/PMI bits) is referred to as coded CQI/PMI.

FIG. 7 is a flow diagram of a method 700 for concatenating multiple periodic channel state information (CSI) reports 236b that are rank indication (RI) to obtain an aggregated rank indication (RI) of an aggregated channel state information (CSI) report. The method 700 may be performed by a user equipment (UE) 104. The aggregated rank indication (RI) may be channel interleaved on the same selected physical uplink shared channel (PUSCH) as the aggregated CQI/PMI. Furthermore, if the selected physical uplink shared channel (PUSCH) is configured with single-user multiple-input and multiple-output (SU-MIMO) with multiple codewords and layers, the aggregated rank indication (RI) may be channel interleaved across all codewords and all layers with resource element alignment. For the selected physical uplink shared channel (PUSCH), the symbol length of the aggregated rank indication (RI) may be calculated using the total aggregated rank indication (RI) payload size N_{RI}^{PUSCH}.

If the periodic channel state information (CSI) reports 236b are rank indication (RI) of the corresponding component carriers (CCs), the rank indication (RI) {q₀, . . . qₘ₋₁} of each periodic channel state information (CSI) report 236b may be concatenated to an aggregated channel state information (CSI) report {r₀, r₁, . . . r _{N}_{_{RI}}_{^{PUSCH}}₋₁} where N_{RI}^{PUSCH} is the payload size of the aggregated channel state information (CSI) report and where m is the length of the aggregated channel state information (CSI) report as decided by the physical uplink control channel (PUCCH) report type and reporting mode.

The user equipment (UE) 104 may set 702 the cell index i=0. Lower indices correspond to lower RRC indices of the corresponding cell. The user equipment (UE) 104 may also set the rank indication (RI) bit index k=0. The user equipment (UE) 104 may further set N_{cells}^{DL} as the number of configured or activated cells by higher layers for the user equipment (UE) 104. The user equipment (UE) 104 may determine 704 whether i<N_{cells}^{DL}. If i<N_{cells}^{DL}, the user equipment (UE) 104 may determine 708 if a periodic channel state information (CSI) report 236a-b is scheduled for the i^{th} downlink cell. If a periodic channel state information (CSI) report 236a-b is not scheduled for the i^{th} downlink cell, the user equipment (UE) 104 may increment 710 i=i+1.

If a periodic channel state information (CSI) report 236a-b is scheduled for the i^{th} downlink cell, the user equipment (UE) 104 may determine 712 whether the periodic channel state information (CSI) report 236a-b is rank indication (RI). If the periodic channel state information (CSI) report 236a-b is not rank indication (RI), the user equipment (UE) 104 may increment 710 i=i+1. If the periodic channel state information (CSI) report 236a-b is rank indication (RI), the user equipment (UE) 104 may obtain 714 the rank indication (RI) of the cell for the aggregated channel state information (CSI) report. The length of the rank indication (RI) {q₀, . . . qₘ₋₁} is m. The user equipment (UE) 104 may set n=0. While n<m 716, the user equipment (UE) 104 may set 718 the bit rⱼ of the aggregated rank indication (RI) equal to the bit qₙ of the rank indication (RI), n=n+1 and k=k+1. Once n=m, the user equipment (UE) 104 may increment 710 i=i+1.

After the user equipment (UE) 104 has incremented 710 i=i+1, the user equipment (UE) 104 may again determine 704 whether i<N_{cells}^{DL}. If i=N_{cells}^{DL}, the user equipment (UE) 104 may generate 706 an aggregated channel state information (CSI) report with the aggregated rank indication (RI) bits {r₀,r₁, . . . r_{N}_{_{RI}}_{^{PUSCH}}₋₁} with a length of N_{RI}^{PUSCH}=k.

As an alternative to the aggregated CQI/PMI and aggregated rank indication (RI) approach, each CQI/PMI or rank indication (RI) of each component carrier (CC) can be treated separately. Thus for each periodic CQI/PMI and periodic rank indication (RI), the user equipment (UE) 104 may calculate the length Q′ of each uplink control information (UCI) 228 multiplexing on the physical uplink shared channel (PUSCH) and then multiplex them following the component carrier (CC) ordering. Thus, multiple symbol length calculations may be used and coding and multiplexing may be performed independently.

In yet another alternative, the aggregated CQI/PMI and the aggregated rank indication (RI) may each be treated as one report block. Thus, one length calculation may be used to decide the number of symbols for each type of channel state information (CSI) on each layer. The aggregated channel state information (CSI) report can normally obtain a better coding gain because aggregated channel state information (CSI) reports have a higher payload than independent channel state information (CSI) reports. For example, for 1 or 2 bits of rank indication (RI), simple repetition or simplex coding may be used. If the aggregated rank indication (RI) payload is great than 2, the Reed Muller code (e.g., (32, O) code) can be employed to get better coding performance.

If some periodic channel state information (CSI) reports 236b are CQI/PMI and some periodic channel state information (CSI) reports 236b are rank indication (RI) of the corresponding component carriers (CCs), the CQI/PMI of those periodic channel state information (CSI) reports 236b may be concatenated to an aggregated CQI/PMI and the rank indication (RI) of those periodic channel state information (CSI) reports 236b may be concatenated to an aggregated rank indication (RI). There may be no dependency between the aggregated CQI/PMI and the aggregated rank indication (RI). The payload of the aggregated CQI/PMI, N_{CQI}^{PUSCH}, may be the sum of all CQI/PMI of all the component carriers (CCs) reporting CQI/PMI. The payload of the aggregated rank indication (RI), N_{RI}^{PUSCH}, may be the sum of all rank indication (RI) of all component carriers (CCs) reporting periodic rank indication (RI). This is different from the periodic channel state information (CSI) reporting of Rel-8/9 where either CQI/PMI or rank indication (RI) is reported, but not both. This is also different from Rel-8/9 aperiodic channel state information (CSI) reporting, where both CQI/PMI and rank indication (RI) are reported, and the CQI/PMI payload size depends on the rank indication (RI) value.

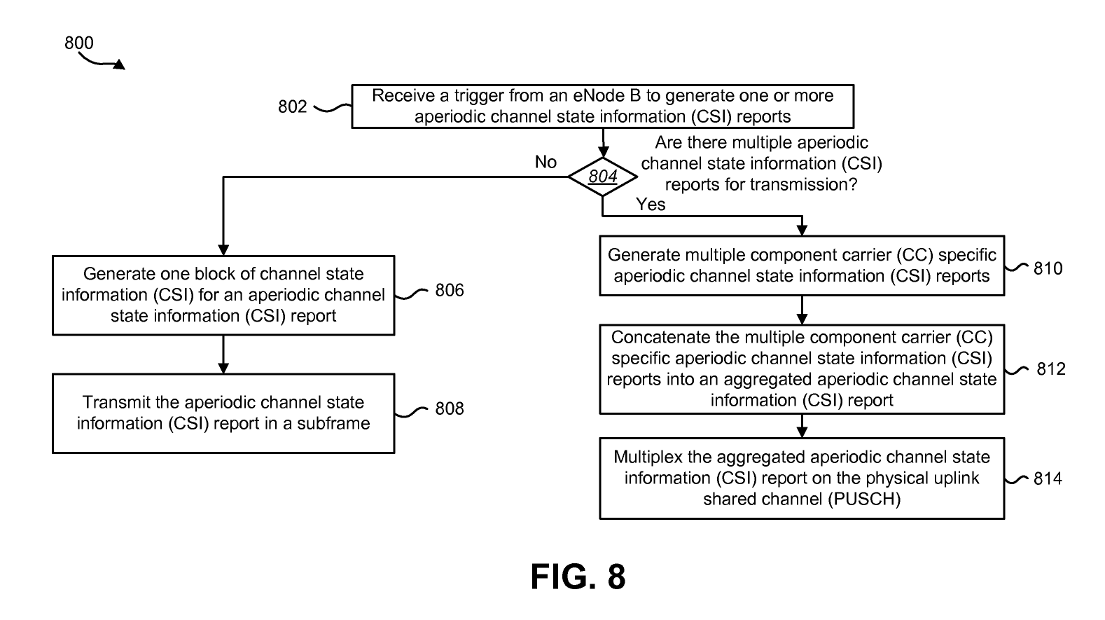

FIG. 8 is a flow diagram of a method 800 for transmitting aperiodic channel state information (CSI) reports 236c on the physical uplink shared channel (PUSCH). The method 800 may be performed by a user equipment (UE) 104. The user equipment (UE) 104 may receive 802 a trigger from an eNode B 102 to generate one or more aperiodic channel state information (CSI) reports 236c. Aperiodic channel state information (CSI) reporting may be triggered by an eNode B 102 in a subframe. An aperiodic channel state information (CSI) report 236c may include both the CQI/PMI and the rank indication (RI) and is always carried on the physical uplink shared channel (PUSCH). In Rel-8/9, only one component carrier (CC) is used. Thus, the aperiodic channel state information (CSI) report 236c and a periodic channel state information (CSI) report 236b are for the same component carrier (CC). In cases where both periodic and aperiodic reporting occur in the same subframe, the user equipment (UE) 104 only transmits the aperiodic channel state information (CSI) report 236c on the physical uplink shared channel (PUSCH) in that subframe.

In Rel-10 and beyond, multiple component carriers (CCs) may be configured for a user equipment (UE) 104. Thus, several types of aperiodic channel state information (CSI) reports 236c may be available. A component carrier (CC) specific aperiodic channel state information (CSI) report 236c, also known as a cell-specific aperiodic channel state information (CSI) report, is an aperiodic channel state information (CSI) report 236c for one specific component carrier (CC). A component carrier (CC) specific aperiodic channel state information (CSI) report 236c may include both CQI/PMI and rank indication (RI). The CQI/PMI in an aperiodic channel state information (CSI) report 236c may be a wideband channel quality indicator (CQI) report, one or more subband channel quality indicator (CQI) reports and/or a user equipment (UE) 104 selected subband CQI/PMI/RI report. For aperiodic channel quality indicator (CQI) reporting, the rank indication (RI) reporting is transmitted only if the configured CQI/PMI/RI feedback type supports rank indication (RI) reporting. If the rank indication (RI) is reported, the payload of the channel quality indicator (CQI) depends on the corresponding rank indication (RI).

An aperiodic channel state information (CSI) report 236c of multiple component carriers (CCs) may include both CQI/PMI and rank indication (RI) for multiple component carriers (CCs). The CQI/PMI may be one or more wideband channel quality indicator (CQI) reports, one or more subband channel quality indicator (CQI) reports of multiple component carriers (CCs) and/or of one or more user equipment (UE) 104 selected component carriers (CCs) and/or one or more user equipment (UE) 104 selected subband CQI/PMI/RI reports. For example, an aperiodic channel state information (CSI) report 236c of multiple component carriers (CCs) may be an aperiodic channel state information (CSI) report 236c for all configured or activated component carriers (CC). In one configuration, multiple aperiodic channel state information (CSI) reports 236c may be generated.

The user equipment (UE) 104 may determine 804 whether there are multiple aperiodic channel state information (CSI) reports 236c for transmission. For component carrier (CC) specific aperiodic channel state information (CSI) reports 236c and aperiodic channel state information (CSI) reports 236c of multiple component carriers (CCs) when there is only one aperiodic channel state information (CSI) report 236 for transmission, only one block of channel state information (CSI) for the component carrier (CC) (or component carriers (CCs)) may be generated 806 for the aperiodic channel state information (CSI) report 236c. The user equipment (UE) 104 may then transmit 808 the aperiodic channel state information (CSI) report 236c in a subframe.

If there are multiple aperiodic channel state information (CSI) reports 236c for transmission, the user equipment (UE) 104 may generate 810 multiple component carrier (CC) specific aperiodic channel state information (CSI) reports 236c. The user equipment (UE) 104 may then concatenate 812 the aperiodic channel state information (CSI) reports 236c into an aggregated aperiodic channel state information (CSI) report. The user equipment (UE) 104 may multiplex 814 the aggregated aperiodic channel state information (CSI) report on the physical uplink shared channel (PUSCH).

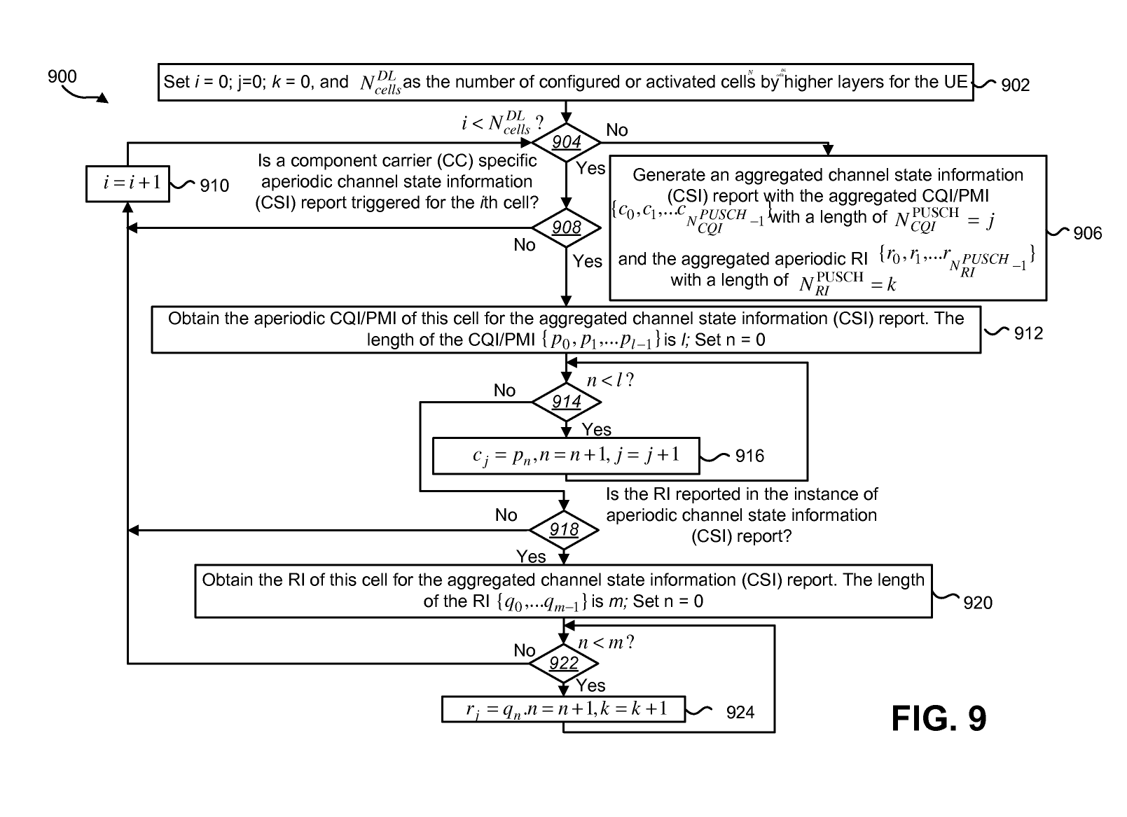

FIG. 9 is a flow diagram of a method 900 for concatenating multiple component carrier (CC) specific aperiodic channel state information (CSI) reports 236c to obtain an aggregated channel state information (CSI) report. The method 900 may be performed by a user equipment (UE) 104. The CQI/PMI of each component carrier (CC) specific aperiodic channel state information (CSI) report 236c may be concatenated to form an aggregated channel state information (CSI) report with aggregated aperiodic CQI/PMI bits {c₀,c₁, . . . c_{N}_{_{CQI}}_{^{PUSCH}}₋₁}, where N_{CQI}^{PUSCH} is the number of aggregated aperiodic CQI/PMI bits. The rank indication (RI) of each component carrier (CC) specific aperiodic channel state information (CSI) report 236c may be concatenated to form an aggregated channel state information (CSI) report with aggregated aperiodic rank indication (RI) bits {r₀, r₁, . . . r_{N}_{_{RI}}_{^{PUSCH}}₋₁}, where N_{RI}^{PUSCH} is the number of aggregated aperiodic rank indication (RI) bits.

The user equipment (UE) 104 may set 902 the cell index i=0. Lower indices correspond to lower RRC indices of the corresponding cell. The user equipment (UE) 104 may also set the CQI/PMI bit index j=0. The user equipment (UE) 104 may further set the rank indication (RI) bit index k=0. The user equipment (UE) 104 may also set N_{cells}^{DL} as the number of configured or activated cells by higher layers for the user equipment (UE) 104. The user equipment (UE) 104 may determine 904 whether i<N_{cells}^{DL}. If i<N_{cells}^{DL}, the user equipment (UE) 104 may determine 908 if a component carrier (CC) specific aperiodic channel state information (CSI) report 236c is triggered for the i^{th} downlink cell. If a component carrier (CC) specific aperiodic channel state information (CSI) report 236c is not triggered for the i^{th} downlink cell, the user equipment (UE) 104 may increment 910 i=i+1.

If a component carrier (CC) specific aperiodic channel state information (CSI) report 236c is triggered for the i^{th} downlink cell, the user equipment (UE) 104 may obtain 912 the aperiodic CQI/PMI of the cell for the aggregated channel state information (CSI) report. The length of the CQI/PMI report {p₀, p₁, . . . pₗ₋₁} is 1. The user equipment (UE) 104 may set n=0. While n<1 914, the user equipment (UE) 104 may set 916 the bit cⱼ of the aggregated CQI/PMI equal to the bit pₙ of the aperiodic CQI/PMI, n=n+1 and j=j+1.

Once n=1, the user equipment (UE) 104 may determine 918 whether the rank indication (RI) is reported in the aperiodic channel state information (CSI) report 236c. If the rank indication (RI) is not reported in the aperiodic channel state information (CSI) report 236c, the user equipment (UE) 104 may increment 910 i=i+1. If the rank indication (RI) is reported in the aperiodic channel state information (CSI) report 236c, the user equipment (UE) 104 may obtain 920 the aperiodic rank indication (RI) of the cell for the aggregated channel state information (CSI) report. The length of the rank indication (RI) {q₀, . . . qₘ₋₁} is m. The user equipment (UE) 104 may set n=0. While n<m 922, the user equipment (UE) 104 may set 924 the bit rⱼ of the aggregated aperiodic rank indication (RI) equal to the bit qₙ of the rank indication (RI), n=n+1 and k=k+1. Once n=m, the user equipment (UE) 104 may increment 910 i=i+1.

After the user equipment (UE) 104 has incremented 910 i=i+1, the user equipment (UE) 104 may again determine 904 whether i<N_{cells}^{DL}. If i=N_{cells}^{DL}, the user equipment (UE) 104 may generate 906 an aggregated channel state information (CSI) report with the aggregated CQI/PMI bits {c₀,c₁, . . . c_{N}_{_{CQI}}_{^{PUSCH}}₋₁} with a length of N_{CQI}^{PUSCH}=j and the aggregated aperiodic rank indication (RI) bits {r₀, r₁, . . . r _{N}_{_{RI}}_{^{PUSCH}}₋₁} with a length of N_{RI}^{PUSCH}=k.

With the concatenation of multiple component carrier (CC) specific aperiodic channel state information (CSI) reports 236c, only one aggregated aperiodic channel state information (CSI) report is multiplexed on the physical uplink shared channel (PUSCH). The uncoded CQI/PMI payload of the aggregated aperiodic channel state information (CSI) report is the sum of the uncoded CQI/PMI payload of the component carrier (CC) specific aperiodic channel state information (CSI) reports 236c. The uncoded rank indication (RI) payload of the aggregated periodic channel state information (CSI) report is the sum of the uncoded rank indication (RI) payload of the component carrier (CC) specific aperiodic channel state information (CSI) reports 236c.

An “instance of aperiodic channel state information (CSI) report” may refer to a component carrier (CC) specific aperiodic channel state information (CSI) report 236c, an aperiodic channel state information (CSI) report 236c from multiple component carriers (CCs), or an aggregated aperiodic channel state information (CSI) report from multiple component carrier (CC) specific aperiodic channel state information (CSI) reports 236c. An instance of aperiodic channel state information (CSI) report may be generated when any type and number of aperiodic channel state information (CSI) reports 236c are triggered. An instance of aperiodic channel state information (CSI) report may also be referred to as “an aperiodic channel state information (CSI) reporting.”

The uncoded CQI/PMI payload of an instance of aperiodic channel state information (CSI) report may be the number of uncoded CQI/PMI payload of a component carrier (CC) specific aperiodic channel state information (CSI) report 236c, the number of uncoded CQI/PMI payload of an aperiodic channel state information (CSI) report 236c for multiple component carriers (CCs) or the number of uncoded CQI/PMI payload of an aggregated aperiodic channel state information (CSI) report from multiple component carrier (CC) specific aperiodic channel state information (CSI) reports 236c. The uncoded rank indication (RI) payload of an instance of aperiodic channel state information (CSI) report may be the number of uncoded rank indication (RI) payload of a component carrier (CC) specific aperiodic channel state information (CSI) report 236c, the number of uncoded rank indication (RI) payload of an aperiodic channel state information (CSI) report 236c for multiple component carriers (CCs) or the number of uncoded rank indication (RI) payload of an aggregated aperiodic channel state information (CSI) report from multiple component carrier (CC) specific aperiodic channel state information (CSI) reports 236c.

If there are multiple physical uplink shared channels (PUSCHs) scheduled for the user equipment (UE) 104, only one physical uplink shared channel (PUSCH) should be selected to carry the uplink control information (UCI) 228. The CQI/PMI may be multiplexed before data and the rank indication (RI) may be channel interleaved on the same selected physical uplink shared channel (PUSCH). If the selected physical uplink shared channel (PUSCH) is configured with single-user multiple-input and multiple-output (SU-MIMO) with multiple codewords and layers, the CQI/PMI may be multiplexed on all layers of one selected codeword and the rank indication (RI) may be channel interleaved across all codewords and all layers with resource element alignment.

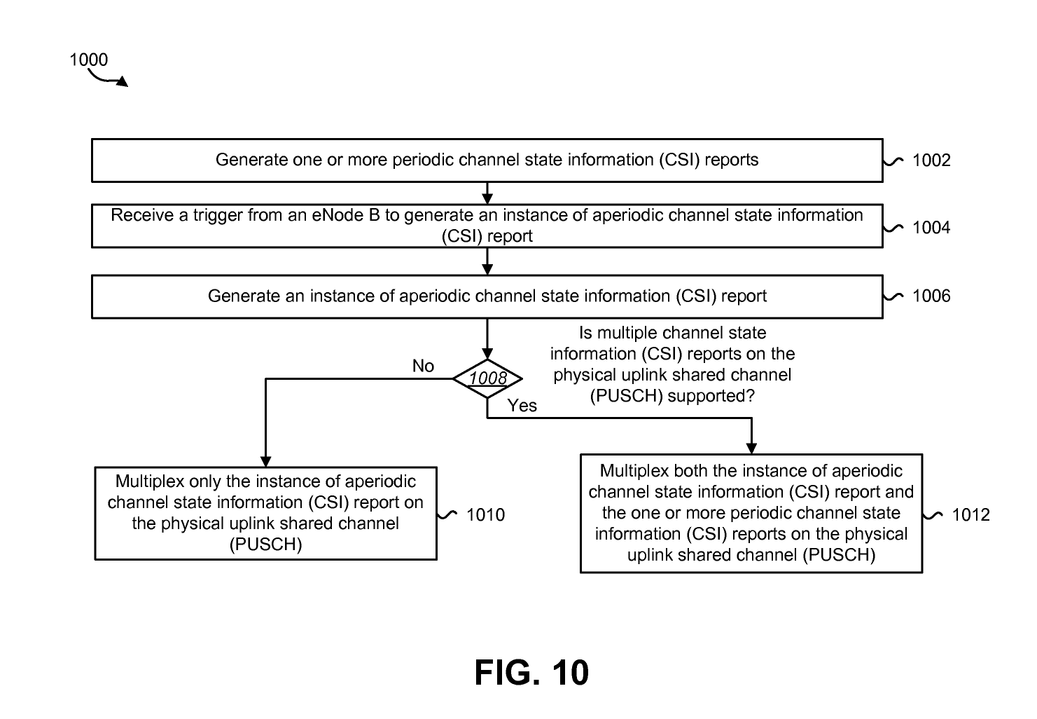

FIG. 10 is a flow diagram of a method 1000 for transmitting uplink control information (UCI) 228 on the physical uplink shared channel (PUSCH). The method 1000 may be performed by a user equipment (UE) 104. In Rel-10 and beyond, an instance of aperiodic channel state information (CSI) report may collide with one or multiple periodic channel state information (CSI) reports 236b. The instance of aperiodic channel state information (CSI) report may have channel state information (CSI) for one component carrier (CC) or multiple component carriers (CCs). The instance of aperiodic channel state information (CSI) report may or may not include channel state information (CSI) for the component carrier (CC) corresponding to the periodic channel state information (CSI) report 236b that it collides with.

When simultaneous physical uplink control channel (PUCCH) and physical uplink shared channel (PUSCH) transmission is not configured, the user equipment (UE) 104 may need to transmit one or more periodic channel state information (CSI) reports 236b on the physical uplink shared channel (PUSCH). If simultaneous physical uplink control channel (PUCCH) and physical uplink shared channel (PUSCH) transmission is configured, the user equipment (UE) 104 may transmit the HARQ-ACK 240a (if present) on the physical uplink control channel (PUCCH). One or more periodic channel state information (CSI) reports 236b may be dropped from the physical uplink control channel (PUCCH) to be transmitted on the physical uplink shared channel (PUSCH). If the HARQ-ACK 240a is not present, multiple periodic channel state information (CSI) reports 236b may be scheduled in the same subframe.

The user equipment (UE) 104 may generate 1002 one or more periodic channel state information (CSI) reports 236b in a subframe. The user equipment (UE) 104 may receive 1004 a trigger from an eNode B 102 to generate an instance of aperiodic channel state information (CSI) report in the same subframe as the generated one or more periodic channel state information (CSI) reports 236b. The user equipment (UE) 104 may then generate 1006 the instance of aperiodic channel state information (CSI) report. The instance of aperiodic channel state information (CSI) report may or may not include channel state information (CSI) corresponding to the component carrier (CC) of the periodic channel state information (CSI) report 236a with the highest priority 210a (i.e., the periodic channel state information (CSI) report 236a transmitted on the physical uplink control channel (PUCCH)).

The user equipment (UE) 104 may determine 1008 whether multiple channel state information (CSI) reports 236 on the physical uplink shared channel (PUSCH) is supported. If multiple channel state information (CSI) reports 236 on the physical uplink shared channel (PUSCH) is supported, simultaneous aperiodic channel state information (CSI) and periodic channel state information (CSI) reporting may be allowed. If simultaneous aperiodic channel state information (CSI) and periodic channel state information (CSI) reporting is supported by the user equipment (UE) 104 and configured by the eNode B 102, the user equipment (UE) 104 may multiplex 1012 both the instance of aperiodic channel state information (CSI) report and the one or more periodic channel state information (CSI) reports 236b on the physical uplink shared channel (PUSCH).

If multiple channel state information (CSI) reporting on the physical uplink shared channel (PUSCH) is not supported, the user equipment (UE) 104 may multiplex 1010 only the instance of aperiodic channel state information (CSI) report on the physical uplink shared channel (PUSCH). If there are multiple physical uplink shared channels (PUSCHs) scheduled for the user equipment (UE) 104, only one physical uplink shared channel (PUSCH) should be selected to carry uplink control information (UCI) 228. Thus, the aperiodic CQI/PMI should be multiplexed on the selected physical uplink shared channel (PUSCH) and the aperiodic rank indication (RI) should be channel interleaved on the same selected physical uplink shared channel (PUSCH). If the selected physical uplink shared channel (PUSCH) is configured with single-user multiple-input and multiple-output (SU-MIMO) with multiple codewords and layers, only one codeword may be selected to carry the aperiodic CQI/PMI. The coded CQI/PMI may be multiplexed on all layers of the selected codeword. The aperiodic rank indication (RI) may be channel interleaved across all codewords and all layers with resource element alignment.

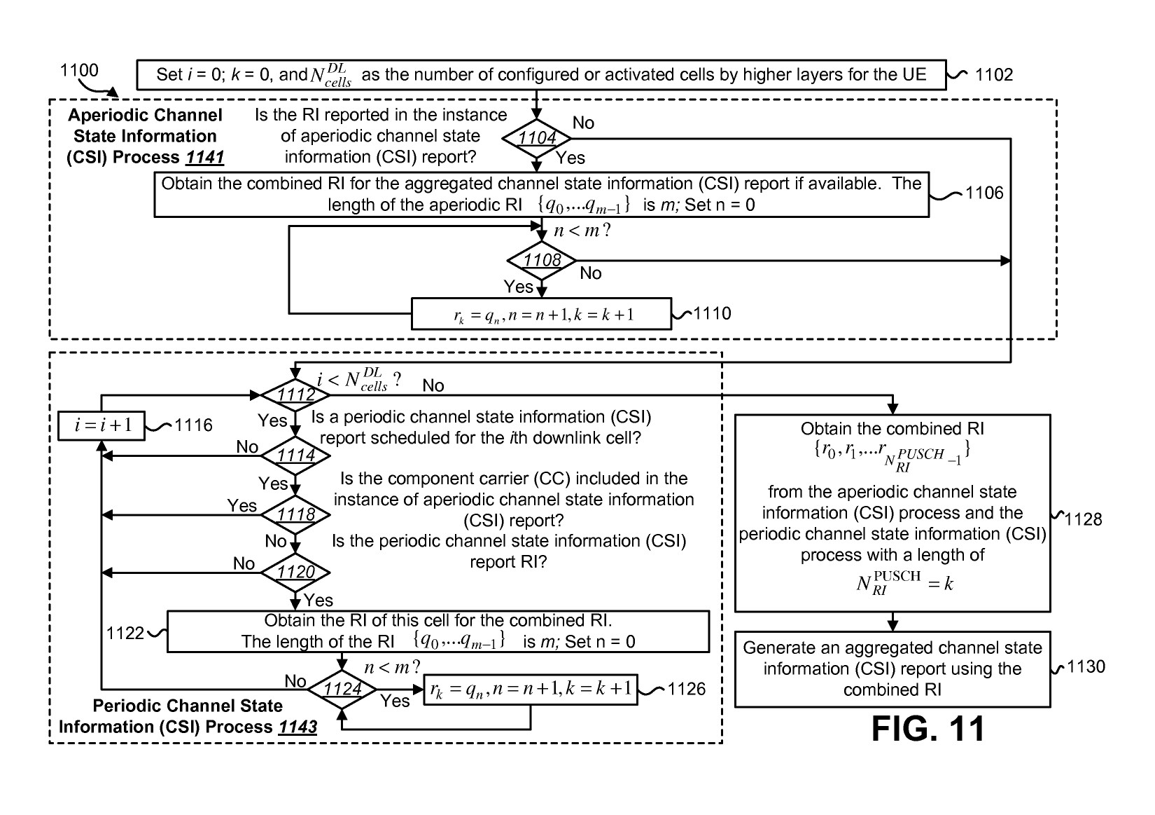

FIG. 11 is a flow diagram of a method 1100 for generating an aggregated channel state information (CSI) report using combined rank indication (RI) from an instance of aperiodic channel state information (CSI) report and one or more periodic channel state information (CSI) reports 236b. The method 1100 may be performed by a user equipment (UE) 104. An aggregated channel state information (CSI) report may include a combined CQI/PMI and/or a combined rank indication (RI) from an instance of aperiodic channel state information (CSI) report and one or more periodic channel state information (CSI) reports 236a-b. If some of the channel state information (CSI) reports are CQI/PMI and some are rank indication (RI), the aggregated channel state information (CSI) report may include both a combined CQI/PMI and a combined rank indication (RI).

The combined rank indication (RI) may be channel interleaved on the selected physical uplink shared channel (PUSCH). If the selected physical uplink shared channel (PUSCH) is configured with single-user multiple-input and multiple-output (SU-MIMO) with multiple codewords and layers, the combined rank indication (RI) may be channel interleaved across all codewords and all layers with resource element alignment. For the selected physical uplink shared channel (PUSCH), the symbol length of the combined rank indication (RI) may be calculated using the total combined rank indication (RI) payload size N_{RI}^{PUSCH}.

The user equipment (UE) 104 may set 1102 the cell index i=0. Lower indices correspond to lower RRC indices of the corresponding cell. The user equipment (UE) 104 may also set the rank indication (RI) bit index k=0. The user equipment (UE) 104 may further set N_{cells}^{DL} as the number of configured or activated cells by higher layers for the user equipment (UE) 104. The user equipment (UE) 104 may then use an aperiodic channel state information (CSI) process 1141 and a periodic channel state information (CSI) process 1143 to obtain an aggregated channel state information (CSI) report.

In the method 1100, the aperiodic channel state information (CSI) report 236c is concatenated before the periodic channel state information (CSI) reports 236b. By switching the order of the aperiodic channel state information (CSI) process 1141 and the periodic channel state information (CSI) process 1143, the aperiodic channel state information (CSI) report 236c can be concatenated after the periodic channel state information (CSI) reports 236b.

In the aperiodic channel state information (CSI) process 1141, the user equipment (UE) 104 may determine 1104 whether the rank indication (RI) is reported in the instance of aperiodic channel state information (CSI) report. If the rank indication (RI) is not reported in the instance of aperiodic channel state information (CSI) report, the user equipment (UE) 104 may switch to the periodic channel state information (CSI) process 1143. If the rank indication (RI) is reported in the instance of aperiodic channel state information (CSI) report, the user equipment (UE) 104 may obtain 1106 the aggregated rank indication (RI) of the cell for the aggregated channel state information (CSI) report, if available. The length of the aperiodic rank indication (RI) {q₀, . . . qₘ₋₁} is m. The user equipment (UE) 104 may set n=0. While n<m 1108, the user equipment (UE) 104 may set 1110 the bit rₖ of the combined rank indication (RI) equal to the bit qₖ of the aperiodic rank indication (RI), n=n+1 and k=k+1. Once n=m, the user equipment (UE) 104 may switch to the periodic channel state information (CSI) process 1143.

In the periodic channel state information (CSI) process 1143, the user equipment (UE) 104 may determine 1112 whether i<N_{cells}^{DL}.If i<N_{cells}^{DL}, the user equipment (UE) 104 may determine 1114 if a periodic channel state information (CSI) is scheduled for the i^{th} downlink cell. If a periodic channel state information (CSI) is not scheduled for the i^{th} downlink cell, the user equipment (UE) 104 may increment 1116 i=i+1.

If a periodic channel state information (CSI) report 236a-b is scheduled for the i^{th} downlink cell, the user equipment (UE) 104 may determine 1118 whether the component carrier (CC) is included in the instance of aperiodic channel state information (CSI) report. If the component carrier (CC) is included in the instance of aperiodic channel state information (CSI) report, the user equipment (UE) 104 may increment 1116 i=i+1. If the component carrier (CC) is not included in the instance of aperiodic channel state information (CSI) report, the user equipment (UE) 104 may determine 1120 whether the periodic channel state information (CSI) report 236b is rank indication (RI). If the periodic channel state information (CSI) report 236b is not rank indication (RI), the user equipment (UE) 104 may increment 1116 i=i+1. If the periodic channel state information (CSI) report 236b is rank indication (RI), the user equipment (UE) 104 may obtain 1122 the rank indication (RI) of this cell for the combined rank indication (RI). The length of the rank indication (RI) {q₀, . . . qₘ₋₁} is m. The user equipment (UE) 104 may set n=0. While n <m 1124, the user equipment (UE) 104 may set 1126 the bit rₖ of the combined rank indication (RI) equal to the bit qₖ of the aperiodic rank indication (RI), n=n+1 and k=k+1. Once n=m, the user equipment (UE) 104 may increment 1116 i=i+1.

After the user equipment (UE) 104 has incremented 1116 i=i+1, the user equipment (UE) 104 may again determine 1112 whether i<N_{cells}^{DL}. If i=N_{cells}^{DL}, the user equipment (UE) 104 may obtain 1128 the combined rank indication (RI) from the aperiodic channel state information (CSI) process 1141 and the periodic channel state information (CSI) process 1143. The user equipment (UE) 104 may then generate 1130 an aggregated channel state information (CSI) report using the combined rank indication(RI) {r₀, r₁, . . . r _{N}_{_{RI}}_{^{PUSCH}}₋₁} with a length of N_{RI}^{PUSCH}=k.

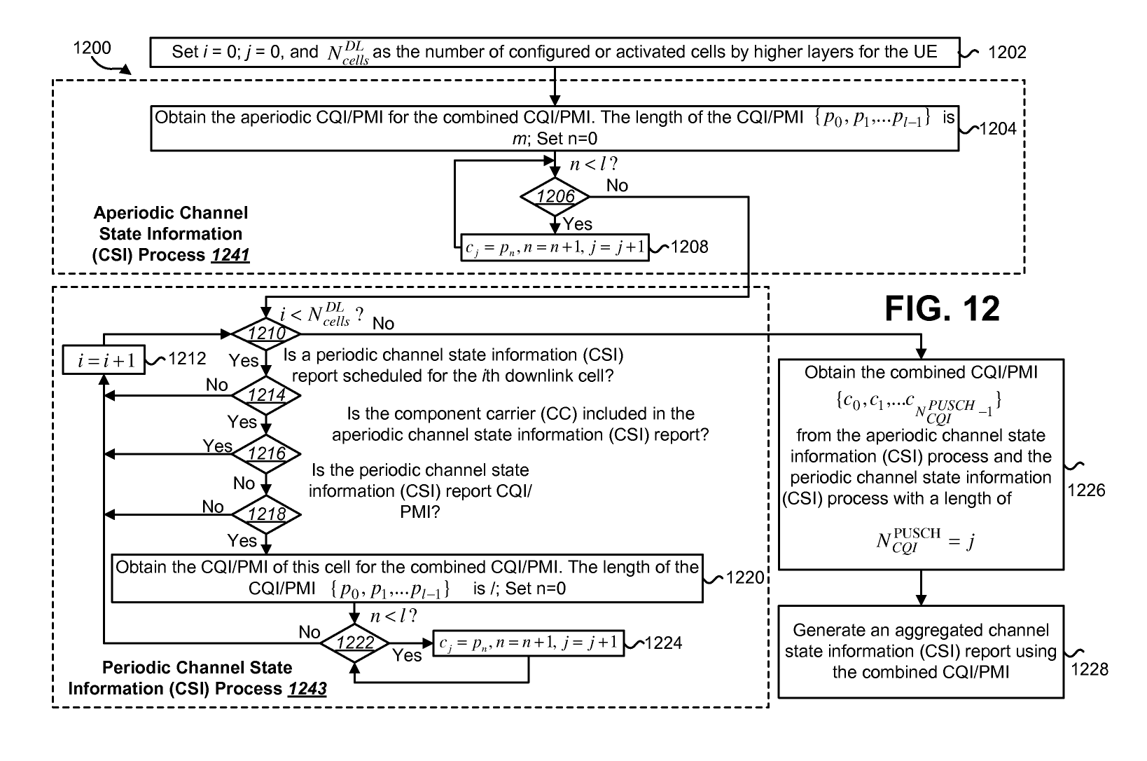

FIG. 12 is a flow diagram of a method 1200 for generating an aggregated channel state information (CSI) report using combined CQI/PMI from an instance of aperiodic channel state information (CSI) report and one or more periodic channel state information (CSI) reports 236b. The method 1200 may be performed by a user equipment (UE) 104. The combined CQI/PMI may be multiplexed on the selected physical uplink shared channel (PUSCH). If the selected physical uplink shared channel (PUSCH) is configured with single-user multiple-input and multiple-output (SU-MIMO) with multiple codewords and layers, only one codeword should be selected to carry the combined CQI/PMI. The coded CQI/PMI should be multiplexed on all layers of the selected codeword. For the selected codeword and physical uplink shared channel (PUSCH), the symbol length of the combined CQI/PMI may be calculated using the total combined CQI/PMI payload size N_{CQI}^{PUSCH}.

The user equipment (UE) 104 may set 1202 the cell index i=0. Lower indices correspond to lower RRC indices of the corresponding cell. The user equipment (UE) 104 may also set the CQI/PMI bit index j=0. The user equipment (UE) 104 may further set N_{cells}^{DL} as the number of configured or activated cells by higher layers for the user equipment (UE) 104. The user equipment (UE) 104 may then use an aperiodic channel state information (CSI) process 1241 and a periodic channel state information (CSI) process 1243 to obtain an aggregated channel state information (CSI) report.

In the method 1200, for the concatenation of CQI/PMI bits for different cells, the instance of aperiodic channel state information (CSI) report is concatenated before the periodic channel state information (CSI) reports 236b. By switching the order of the aperiodic channel state information (CSI) process 1241 and the periodic channel state information (CSI) process 1243, the instance of aperiodic channel state information (CSI) report can be concatenated after the periodic channel state information (CSI) reports 236b.

In the aperiodic channel state information (CSI) process 1241, the user equipment (UE) 104 may obtain 1204 the aperiodic CQI/PMI for the combined CQI/PMI. The length of the CQI/PMI {p₀, p₁, . . . pₗ₋₁} is 1. The user equipment (UE) 104 may set n=0. While n</ 1206, the user equipment (UE) 104 may set 1208 the bit c ⱼ of the combined CQI/PMI equal to the bit pₙ of the aperiodic CQI/PMI, n=n+1 and j=j+1. Once n=I, the user equipment (UE) 104 may switch to the periodic channel state information (CSI) process 1243.

In the periodic channel state information (CSI) process 1243, the user equipment (UE) 104 may determine 1210 whether i<N_{cells}^{DL}. If i<N_{cells}^{DL}, the user equipment (UE) 104 may determine 1214 if a periodic channel state information (CSI) is scheduled for the i^{th} downlink cell. If a periodic channel state information (CSI) is not scheduled for the i^{th} downlink cell, the user equipment (UE) 104 may increment 1212 i=i+1.

If a periodic channel state information (CSI) is scheduled for the i^{th} downlink cell, the user equipment (UE) 104 may determine 1216 whether the component carrier (CC) is included in the aperiodic channel state information (CSI) report 236c. If the component carrier (CC) is included in the aperiodic channel state information (CSI) report 236c, the user equipment (UE) 104 may increment 1212 i=i+1. If the component carrier (CC) is not included in the aperiodic channel state information (CSI) report 236c , the user equipment (UE) 104 may determine 1218 whether the periodic channel state information (CSI) report 236b is CQI/PMI. If the periodic channel state information (CSI) report 236b is not CQI/PMI, the user equipment (UE) 104 may increment 1212 i=i+1. If the periodic channel state information (CSI) report 236b is CQI/PMI, the user equipment (UE) 104 may obtain 1220 the CQI/PMI of this cell for the combined CQI/PMI. The length of the CQI/PMI {p₀,p₁, . . . pₗ₋₁} is 1. The user equipment (UE) 104 may set n=0. While n<1 1222, the user equipment (UE) 104 may set 1224 the bit cⱼ of the combined CQI/PMI equal to the bit pₙ of the aperiodic CQI/PMI, n=n+1 and j=j+1. Once n=m, the user equipment (UE) 104 may increment 1212 i=i+1.

After the user equipment (UE) 104 has incremented 1212 i=i+1, the user equipment (UE) 104 may again determine 1210 whether i<N_{cells}^{DL}. If i=N_{cells}^{DL}, the user equipment (UE) 104 may obtain 1226 the combined CQI/PMI {c₀,c₁, . . . c_{N}_{_{CQI}}_{^{PUSCH}}₋₁} from the aperiodic channel state information (CSI) process 1241 and the periodic channel state information (CSI) process 1243. The user equipment (UE) 104 may then generate 1228 an aggregated channel state information (CSI) report using the combined CQI/PMI {c₀,c₁, . . . c_{N}_{_{CQI}}_{^{PUSCH}}₋₁} with a length of N_{CQI}^{PUSCH}=j.

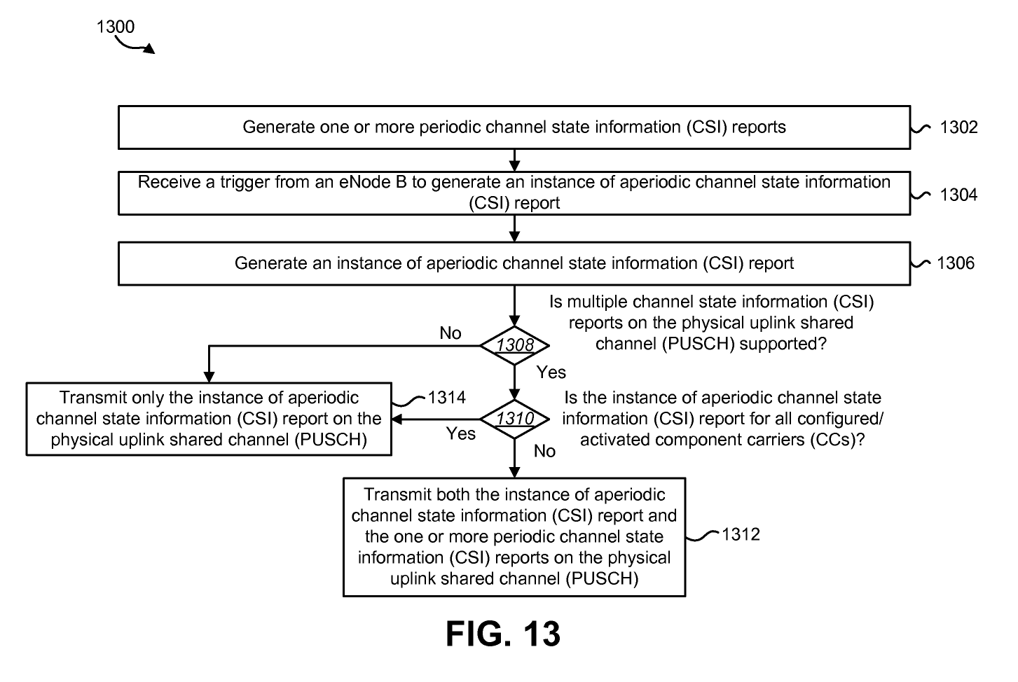

FIG. 13 is a flow diagram of another method 1300 for transmitting uplink control information (UCI) 228 on the physical uplink shared channel (PUSCH). The method 1300 may be performed by a user equipment (UE) 104. The user equipment (UE) 104 may include a configuration parameter that indicates whether the user equipment (UE) 104 sends an instance of aperiodic channel state information (CSI) report for all configured/activated downlink cells or whether the user equipment (UE) 104 sends an instance of aperiodic channel state information (CSI) report for a specific downlink cell. The configuration parameter may be linked to the periodic channel state information (CSI) configuration.

If the user equipment (UE) 104 is configured to send an instance of aperiodic channel state information (CSI) report for all configured/activated downlink cells, when an instance of aperiodic channel state information (CSI) report collides with one or more periodic channel state information (CSI) reports 236b all the periodic channel state information (CSI) reports 236b are dropped. If the user equipment (UE) 104 is configured to send an instance of aperiodic channel state information (CSI) report for a specific downlink cell, when a component carrier (CC) specific aperiodic channel state information (CSI) report 236c collides with one or more periodic channel state information (CSI) reports 236b, all the periodic channel state information (CSI) reports 236b may be transmitted on the physical uplink shared channel (PUSCH) together with the component carrier (CC) specific aperiodic channel state information (CSI) report 236c.

The user equipment (UE) 104 may generate 1302 one or more periodic channel state information (CSI) reports 236b. The user equipment (UE) 104 may receive 1304 a trigger from an eNode B 102 to generate an instance of aperiodic channel state information (CSI) report 236c. The user equipment (UE) 104 may then generate 1306 an instance of aperiodic channel state information (CSI) report. The user equipment (UE) 104 may determine 1308 whether multiple channel state information (CSI) reports 236 on the physical uplink shared channel (PUSCH) is supported. If multiple channel state information (CSI) reports 236 on the physical uplink shared channel (PUSCH) is not supported, the user equipment (UE) 104 may transmit 1314 only the instance of aperiodic channel state information (CSI) report on the physical uplink shared channel (PUSCH). If multiple channel state information (CSI) reports 236 on the physical uplink shared channel (PUSCH) is supported, the user equipment (UE) 104 may determine 1310 whether the instance of aperiodic channel state information (CSI) report is for all configured/activated component carriers (CCs).

If the instance of aperiodic channel state information (CSI) report is for all configured/activated component carriers (CCs), the user equipment (UE) 104 may transmit 1314 only the instance of aperiodic channel state information (CSI) report on the physical uplink shared channel (PUSCH). If the instance of aperiodic channel state information (CSI) report is not for all configured/activated component carriers (CCs), the user equipment (UE) 104 may transmit 1312 both the instance of aperiodic channel state information (CSI) report and the one or more periodic channel state information (CSI) reports 236b on the physical uplink shared channel (PUSCH).

In one configuration that may be configured by the eNode B 102, the instance of aperiodic channel state information (CSI) report and the periodic channel state information (CSI) reports 236b of the component carriers (CCs) that are not included in the instance of aperiodic channel state information (CSI) report may be reported together on the physical uplink shared channel (PUSCH). For a periodic channel state information (CSI) report 236b of one component carrier (CC), the user equipment (UE) 104 may first check if the channel state information (CSI) of the same component carrier (CC) is included in the instance of aperiodic channel state information (CSI) report. If the periodic channel state information (CSI) report 236b is for the same component carrier (CC) as that reported in the instance of aperiodic channel state information (CSI) report, the periodic channel state information (CSI) report 236b for that particular component carrier (CC) may be dropped. Otherwise, the periodic channel state information (CSI) report 236b and the instance of aperiodic channel state information (CSI) report may be transmitted together.

One way to multiplex one or more periodic channel state information (CSI) reports 236b and an instance of aperiodic channel state information (CSI) report is to treat them separately. The one or more periodic channel state information (CSI) reports 236b may be multiplexed before the instance of aperiodic channel state information (CSI) report. A periodic CQI/PMI report may be multiplexed before the instance of aperiodic channel state information (CSI) report because the periodic CQI/PMI size is already known to the eNode B 102. The aperiodic CQI/PMI may be multiplexed after the periodic CQI/PMI. Similarly, the rank indication (RI) from the periodic channel state information (CSI) may be channel interleaved on the rank indication (RI) location first because the size of the rank indication (RI) is already known to the eNode B 102. The aperiodic rank indication (RI) may be channel interleaved after the rank indication (RI) from the periodic channel state information (CSI).

At the eNode B 102, the aperiodic CQI/PMI payload size may be obtained after the aperiodic rank indication (RI) is decoded. Thus, more complexity may be introduced when the one or more periodic channel state information (CSI) reports 236b and an instance of aperiodic channel state information (CSI) report are treated separately because separate length calculations may be necessary for periodic and aperiodic channel state information (CSI) reports 236. However, treating the one or more periodic channel state information (CSI) reports 236b and an instance of aperiodic channel state information (CSI) report separately allows separate detection and decoding of the periodic and aperiodic channel state information (CSI). Thus, the miss detection of an aperiodic rank indication (RI) may not cause problems with the periodic channel state information (CSI) reporting.

The periodic channel state information (CSI) reports 236b and the instance of aperiodic channel state information (CSI) report may instead be concatenated together. The periodic channel state information (CSI) reports 236b of the component carriers (CCs) that are not included in the instance of aperiodic channel state information (CSI) report may be grouped together first, and then concatenated with the instance of aperiodic channel state information (CSI) report. The aperiodic CQI/PMI may be put after the aggregated CQI/PMI from the periodic channel state information (CSI) report 236b to form a combined CQI/PMI. The aperiodic rank indication (RI) may be put after the aggregated rank indication (RI) from the periodic channel state information (CSI) reports 236b to form a combined rank indication (RI). Alternatively, the aperiodic CQI/PMI may be put before the aggregated CQI/PMI from the periodic channel state information (CSI) reports 236b to form a combined CQI/PMI and the aperiodic rank indication (RI) may be put before the aggregated rank indication (RI) from the periodic channel state information (CSI) reports 236b to form a combined rank indication (RI). Unlike the separate coding and multiplexing discussed above, the combined CQI/PMI is jointly coded. Thus, the order of the instance of aperiodic channel state information (CSI) report and the periodic channel state information (CSI) report 236b has no impact on the performance but must be defined. Once defined, the same rule may also apply to the combined rank indication (RI).

The uncoded payload of the combined CQI/PMI, N_{CQI}^{PUSCH}, is the sum of the uncoded CQI/PMI payload of the instance of the aperiodic channel state information (CSI) report and the aggregated CQI/PMI of all the periodic CQI/PMI reports of the component carriers (CCs) that are not included in the instance of aperiodic channel state information (CSI) report. The uncoded payload of the combined rank indication (RI), N_{RI}^{PUSCH}, is the sum of the uncoded rank indication (RI) payload of the instance of the aperiodic channel state information (CSI) report and the aggregated rank indication (RI) of all the periodic rank indication (RI) reports of the component carriers (CCs) that are not included in the instance of aperiodic channel state information (CSI) report. The length of the aperiodic CQI/PMI part may depend on the aperiodic rank indication (RI) part only if the rank indication (RI) is reported in the instance of aperiodic channel state information (CSI) report.

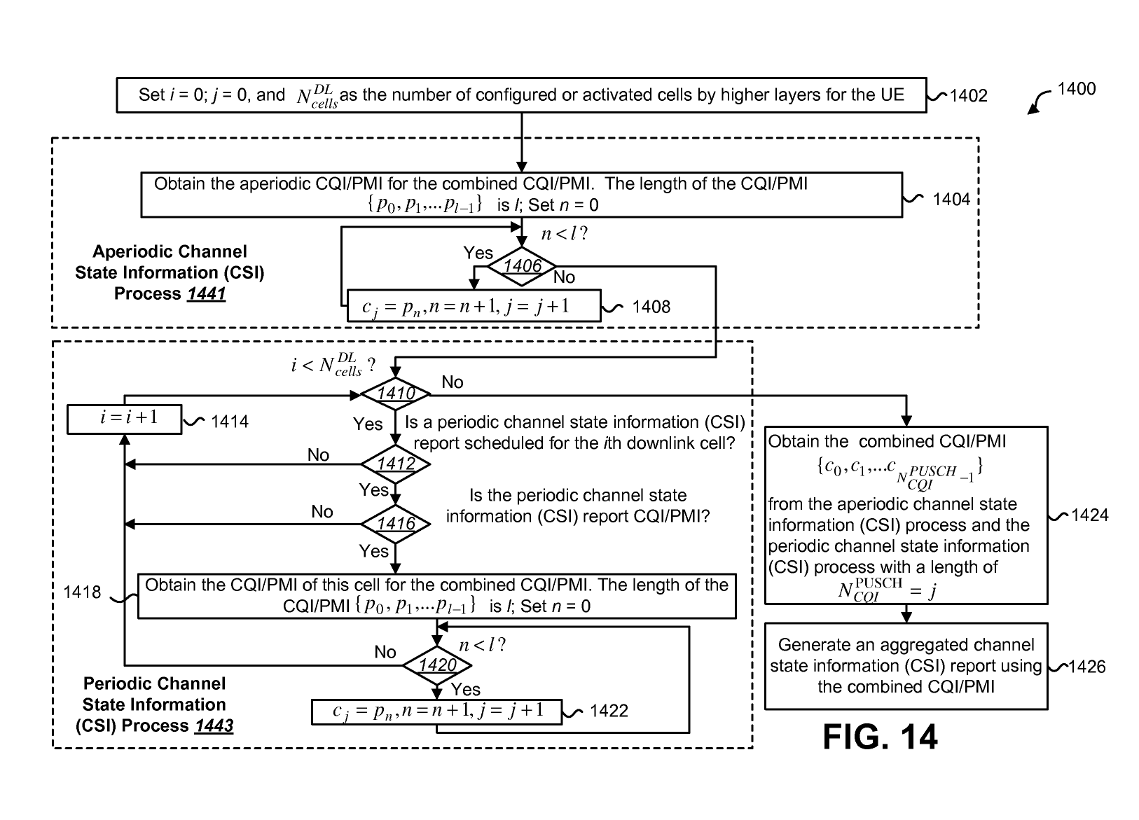

FIG. 14 is a flow diagram of a method 1400 for generating an aggregated channel state information (CSI) report using combined CQI/PMI from an aperiodic channel state information (CSI) report 236cthat is for a specific downlink component carrier (CC) and one or more periodic channel state information (CSI) reports 236b. The method 1400 may be performed by a user equipment (UE) 104. The combined CQI/PMI may be multiplexed on the selected physical uplink shared channel (PUSCH). If the selected physical uplink shared channel (PUSCH) is configured with single-user multiple-input and multiple-output (SU-MIMO) with multiple codewords and layers, only one codeword should be selected to carry the combined CQI/PMI. The coded CQI/PMI should be multiplexed on all layers of the selected codeword. For the selected codeword and physical uplink shared channel (PUSCH), the symbol length of the combined CQI/PMI may be calculated using the total combined CQI/PMI payload size N_{CQI}^{PUSCH}.

In the method 1400, for the concatenation of CQI/PMI bits for different cells, the aperiodic channel state information (CSI) report 236cis concatenated before the periodic channel state information (CSI) reports 236b. By switching the order of the aperiodic channel state information (CSI) process 1441 and the periodic channel state information (CSI) process 1443, the aperiodic channel state information (CSI) report 236ccan be concatenated after the periodic channel state information (CSI) reports 236b.

The user equipment (UE) 104 may set 1402 the cell index i=0. Lower indices correspond to lower RRC indices of the corresponding cell. The user equipment (UE) 104 may also set the CQI/PMI bit index j=0. The user equipment (UE) 104 may further set N_{cells}^{DL} as the number of configured or activated cells by higher layers for the user equipment (UE) 104. The user equipment (UE) 104 may use an aperiodic channel state information (CSI) process 1441 and a periodic channel state information (CSI) process 1443 to obtain an aggregated channel state information (CSI) report.

In the aperiodic channel state information (CSI) process 1441, the user equipment (UE) 104 may obtain 1404 the aperiodic CQI/PMI for the combined CQI/PMI. The length of the CQI/PMI {p₀,p₁, . . . pₗ₋₁} is 1. The user equipment (UE) 104 may set n=0. While n<1 1406, the user equipment (UE) 104 may set 1408 the bit cⱼ of the combined CQI/PMI equal to the bit pₙ of the aperiodic CQI/PMI, n=n+1 and j=j+1. Once n=I, the user equipment (UE) 104 may switch to the periodic channel state information (CSI) process 1443.

In the periodic channel state information (CSI) process 1443, the user equipment (UE) 104 may determine 1410 whether i<N_{cells}^{DL}. If i<N_{cells}^{DL}, the user equipment (UE) 104 may determine 1412 if a periodic channel state information (CSI) is scheduled for the i^{th} downlink cell. If a periodic channel state information (CSI) is not scheduled for the i^{th} downlink cell, the user equipment (UE) 104 may increment 1414 i=i+1.

If a periodic channel state information (CSI) report 236b is scheduled for the i^{th} downlink cell, the user equipment (UE) 104 may determine 1416 whether the periodic channel state information (CSI) report 236b is CQI/PMI. If the periodic channel state information (CSI) report 236b is not CQI/PMI, the user equipment (UE) 104 may increment 1414 i=i+1. If the periodic channel state information (CSI) report 236b is CQI/PMI, the user equipment (UE) 104 may obtain 1418 the CQI/PMI of the cell for the combined CQI/PMI. The length of the CQI/PMI {p₀,p₁, . . . pₗ₋₁} is 1. The user equipment (UE) 104 may set n=0. While n</ 1420, the user equipment (UE) 104 may set 1422 the bit cⱼ of the combined CQI/PMI equal to the bit pₙ of the aperiodic CQI/PMI, n=n+1 and j=j+1. Once n=m, the user equipment (UE) 104 may increment 1414 i=i+1.

After the user equipment (UE) 104 has incremented 1414 i=i+1, the user equipment (UE) 104 may again determine 1410 whether i<N_{cells}^{DL}. If i=N_{cells}^{DL}, the user equipment (UE) 104 may obtain 1424 the combined CQI/PM I {c₀,c₁, . . . c_{N}_{_{CQI}}_{^{PUSCH}}₋₁} from the aperiodic channel state information (CSI) process 1441 and the periodic channel state information (CSI) process 1443. The user equipment (UE) 104 may then generate 1426 an aggregated channel state information (CSI) report using the combined CQI/PMI {c₀,c₁, . . . c_{N}_{_{CQI}}_{^{PUSCH}}₋₁} with a length of N_{CQI}^{PUSCH}=j.

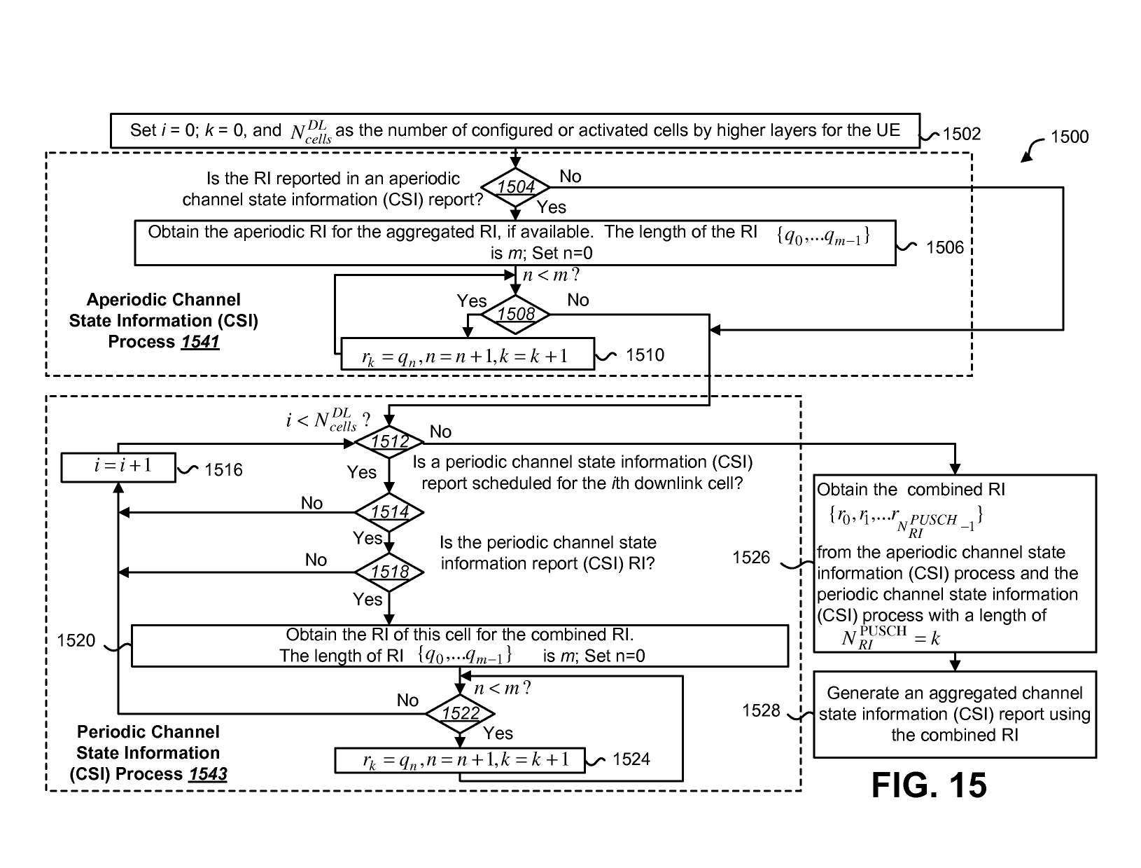

FIG. 15 is a flow diagram of a method 1500 for generating an aggregated channel state information (CSI) report using combined rank indication (RI) from an aperiodic channel state information (CSI) report 236cand one or more periodic channel state information (CSI) reports 236b. The method 1500 may be performed by a user equipment (UE) 104. The combined rank indication (RI) may be channel interleaved on the selected physical uplink shared channel (PUSCH). If the selected physical uplink shared channel (PUSCH) is configured with single-user multiple-input and multiple-output (SU-MIMO) with multiple codewords and layers, the combined rank indication (RI) may be channel interleaved across all codewords and all layers with resource element alignment. For the selected physical uplink shared channel (PUSCH), the symbol length of the combined rank indication (RI) may be calculated using the total combined rank indication (RI) payload size N_{RI}^{PUSCH}.

In the method 1500, the aperiodic channel state information (CSI) report 236c is concatenated before the periodic channel state information (CSI) reports 236b. By switching the order of the aperiodic channel state information (CSI) process 1541 and the periodic channel state information (CSI) process 1543, the aperiodic channel state information (CSI) report 236ccan be concatenated after the periodic channel state information (CSI) reports 236b.

The user equipment (UE) 104 may set 1502 the cell index i=0. Lower indices correspond to lower RRC indices of the corresponding cell. The user equipment (UE) 104 may also set the rank indication (RI) bit index k=0. The user equipment (UE) 104 may further set N_{cells}^{DL} is as the number of configured or activated cells by higher layers for the user equipment (UE) 104. The user equipment (UE) 104 may then use an aperiodic channel state information (CSI) process 1541 and a periodic channel state information (CSI) process 1543 to obtain an aggregated channel state information (CSI) report.

In the aperiodic channel state information (CSI) process 1541, the user equipment (UE) 104 may determine 1504 whether the rank indication (RI) is reported in an aperiodic channel state information (CSI) report 236c. If the rank indication (RI) is not reported in the aperiodic channel state information (CSI) report 236c, the user equipment (UE) 104 may switch to the periodic channel state information (CSI) process 1543. If the rank indication (RI) is reported in the aperiodic channel state information (CSI) report, the user equipment (UE) 104 may obtain 1506 the aperiodic rank indication (RI) of the cell for the aggregated rank indication (RI), if available. The length of the rank indication (RI) {q₀, . . . qₘ₋₁} is m. The user equipment (UE) 104 may set n=0. While n<m 1508, the user equipment (UE) 104 may set 1510 the bit rₖ of the combined rank indication (RI) equal to the bit qₙ of the aperiodic rank indication (RI), n =n+1 and k=k+1. Once n=m, the user equipment (UE) 104 may switch to the periodic channel state information (CSI) process 1543.

In the periodic channel state information (CSI) process 1543, the user equipment (UE) 104 may determine 1512 whether i<N_{cells}^{DL}. If i<N_{cells}^{DL}, the user equipment (UE) 104 may determine 1514 if a periodic channel state information (CSI) report 236b is scheduled for the i^{th} downlink cell. If a periodic channel state information (CSI) report 236b is not scheduled for the i^{th} downlink cell, the user equipment (UE) 104 may increment 1516 i=i+1.

If a periodic channel state information (CSI) report 236b is scheduled for the i^{th} downlink cell, the user equipment (UE) 104 may determine 1518 whether the periodic channel state information (CSI) report 236b is rank indication (RI). If the periodic channel state information (CSI) report 236b is not rank indication (RI), the user equipment (UE) 104 may increment 1516 i=i+1. If the periodic channel state information (CSI) report 236b is rank indication (RI), the user equipment (UE) 104 may obtain 1520 the rank indication (RI) report of this cell for the combined rank indication (RI). The length of the rank indication (RI) {q₀, . . . qₘ₋₁} is m. The user equipment (UE) 104 may set n=0. While n<m 1522, the user equipment (UE) 104 may set 1524 the bit rₖ of the combined rank indication (RI) equal to the bit qₙ of the aperiodic rank indication (RI), n=n+1 and k=k+1. Once n=m, the user equipment (UE) 104 may increment 1516 i=i+1.

After the user equipment (UE) 104 has incremented 1516 i=i+1, the user equipment (UE) 104 may again determine 1512 whether i<N_{cells}^{DL}. If i=N_{cells}^{DL}, the user equipment (UE) 104 may obtain 1526 the combined rank indication (RI) from the aperiodic channel state information (CSI) process 1543 and the periodic channel state information (CSI) process 1543. The user equipment (UE) 104 may then generate 1528 an aggregated channel state information (CSI) report using the combined rank indication(RI) {r₀, r₁, . . . r_{N}_{_{RI}}_{^{PUSCH}}₋₁} with a length of N_{RI}^{PUSCH}=k.

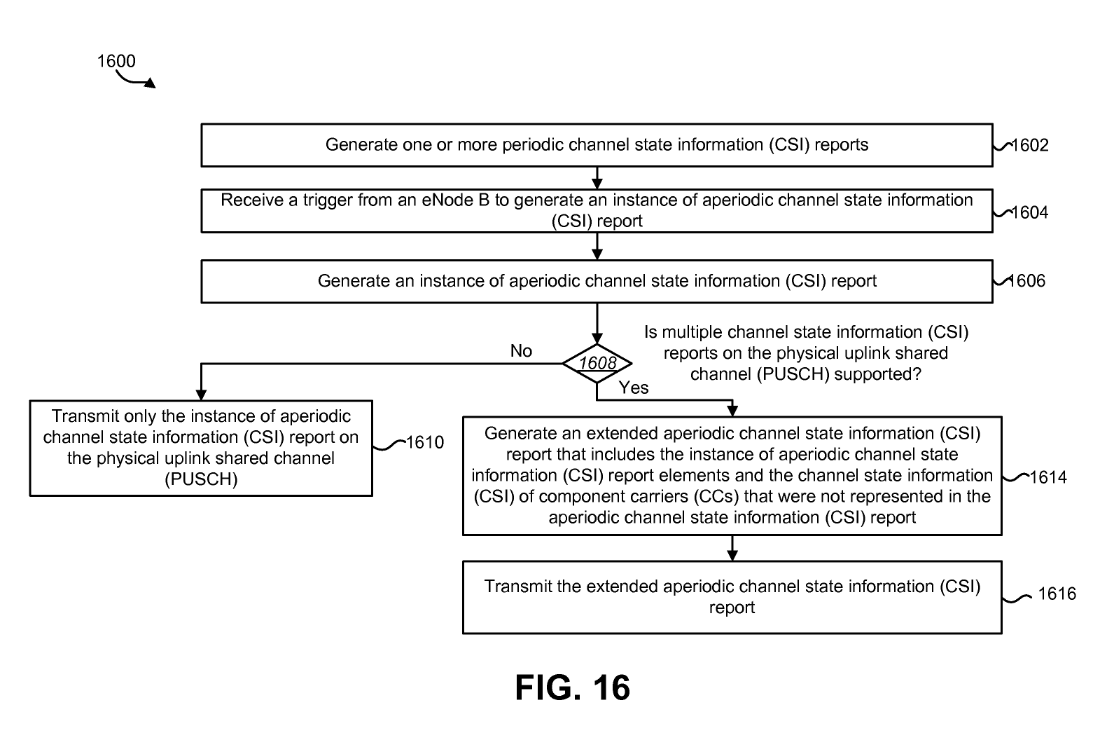

FIG. 16 is a flow diagram of a method 1600 for transmitting an extended aperiodic channel state information (CSI) report. The method 1600 may be performed by a user equipment (UE) 104. When one or more periodic channel state information (CSI) reports 236b are scheduled at the same subframe where an instance of aperiodic channel state information (CSI) report is also triggered, an extended channel state information (CSI) report may be generated and transmitted while all the periodic channel state information (CSI) reports 236b are dropped.

The user equipment (UE) 104 may generate 1602 one or more periodic channel state information (CSI) reports 236b for a subframe. The user equipment (UE) 104 may receive 1604 a trigger from an eNode B 102 to generate an instance of aperiodic channel state information (CSI) report for the same subframe. The user equipment (UE) 104 may then generate 1606 an instance of aperiodic channel state information (CSI) report 236c.

The user equipment (UE) 104 may determine 1608 whether multiple channel state information (CSI) reports 236b on the physical uplink shared channel (PUSCH) is supported. If multiple channel state information (CSI) reports 236b on the physical uplink shared channel (PUSCH) is not supported, the user equipment (UE) 104 may transmit 1610 only the instance of aperiodic channel state information (CSI) report on the physical uplink shared channel (PUSCH). If multiple channel state information (CSI) reports 236 on the physical uplink shared channel (PUSCH) is supported, the user equipment (UE) 104 may generate 1614 an extended aperiodic channel state information (CSI) report that includes the instance of aperiodic channel state information (CSI) report elements and new channel state information (CSI) elements from the component carriers (CCs) that were not represented in the instance of aperiodic channel state information (CSI) report. The user equipment (UE) 104 may then transmit 1616 the extended aperiodic channel state information (CSI) report.

As an example, if the periodic channel state information (CSI) report 236b of a component carrier (CC) is scheduled in the same subframe as an instance of aperiodic channel state information (CSI) report, the user equipment (UE) 104 may first check if the component carrier (CC) is already represented in the instance of aperiodic channel state information (CSI) report. If the component carrier (CC) is already represented in the instance of aperiodic channel state information (CSI) report, the periodic channel state information (CSI) report 236b corresponding to the component carrier (CC) should be dropped. If the component carrier (CC) is not represented in the instance of aperiodic channel state information (CSI) report, the information in the periodic channel state information (CSI) report 236b corresponding to the component carrier (CC) should be added to the extended aperiodic channel state information (CSI) report.

If the periodic channel state information (CSI) report 236b of the component carrier (CC) is a CQI/PMI, the extended aperiodic channel state information (CSI) report may include the CQI/PMI of the periodic channel state information (CSI) report 236b of the component carrier (CC). If the periodic channel state information (CSI) report 236b of the component carrier (CC) is a rank indication (RI), the extended aperiodic channel state information (CSI) report may include both the periodic rank indication (RI) report and the periodic channel state information (CSI) report 236b of the component carrier (CC). This is because in an aperiodic channel state information (CSI) report 236c, if the rank indication (RI) of a component carrier (CC) is transmitted, the CQI/PMI of the component carrier (CC) should also be transmitted, and the CQI/PMI payload depends on the rank indication (RI) value. On the other hand, a periodic channel state information (CSI) report 236b has either CQI/PMI or rank indication (RI), but not both.

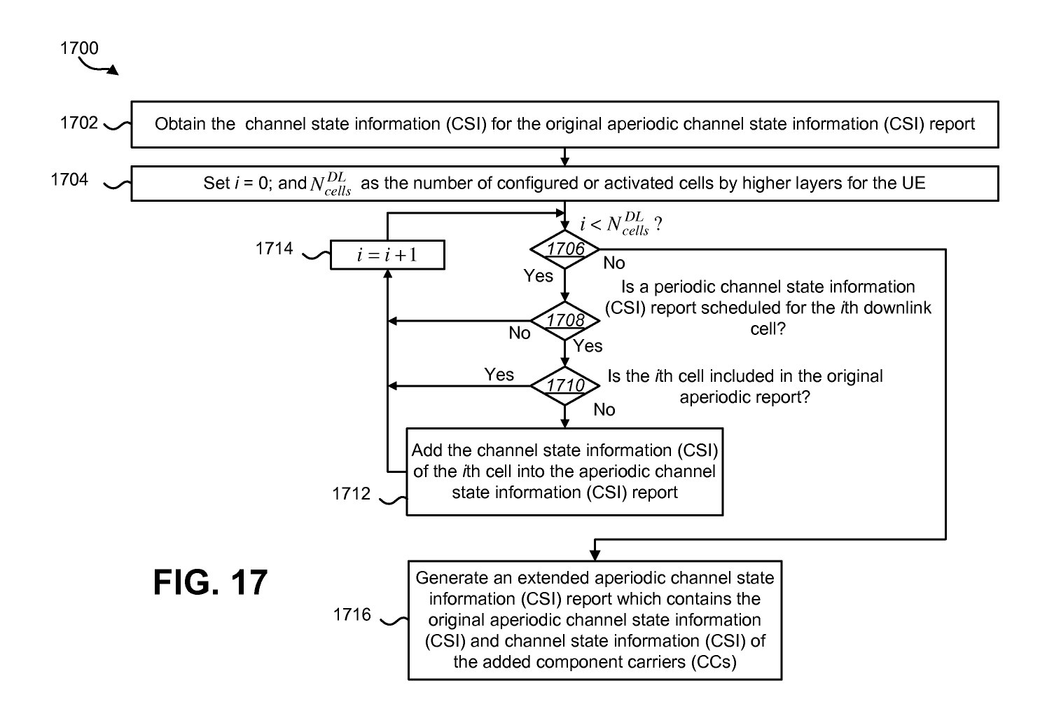

FIG. 17 is a flow diagram of a method 1700 for generating an extended aperiodic channel state information (CSI) report 236c. The method 1700 may be performed by a user equipment (UE) 104. The user equipment (UE) 104 may obtain 1702 the channel state information (CSI) for the original aperiodic channel state information (CSI) report 236c. The user equipment (UE) 104 may set 1704 the cell index i=0. Lower indices correspond to lower RRC indices of the corresponding cell. The user equipment (UE) 104 may also set N_{cells}^{DL} as the number of configured or activated cells by higher layers for the user equipment (UE) 104.

The user equipment (UE) 104 may determine 1706 whether i<N_{cells}^{DL}. If i<N_{cells}^{DL}, the user equipment (UE) 104 may determine 1708 if a periodic channel state information (CSI) report 236b is scheduled for the i^{th} downlink cell. If a periodic channel state information (CSI) report 236b is not scheduled for the i^{th} downlink cell, the user equipment (UE) 104 may increment 1714 i=i+1. If a periodic channel state information (CSI) report 236b is scheduled for the i^{th} downlink cell, the user equipment (UE) 104 may determine 1710 whether the i^{th} cell is included in the original aperiodic channel state information (CSI) report 236c. If the i^{th} cell is included in the original aperiodic channel state information (CSI) report, the user equipment (UE) 104 may increment 1714 i=i+1. If the i^{th} cell is not included in the original aperiodic channel state information (CSI) report 236c, the user equipment (UE) 104 may add 1712 the channel state information (CSI) of the i^{th} cell into the aperiodic channel state information (CSI) report 236c. The user equipment (UE) 104 may then increment 1714 i=i+1.

After the user equipment (UE) 104 has incremented 1714 i=i+1, the user equipment (UE) 104 may again determine 1706 whether i<N_{cells}^{DL}. If i=N_{cells}^{DL}, the user equipment (UE) 104 may generate 1716 an extended aperiodic channel state information (CSI) report 236c with the original aperiodic channel state information (CSI) report 236c and the obtained channel state information (CSI) of the added component carriers (CCs). Thus, only the extended aperiodic channel state information (CSI) report is multiplexed on the physical uplink shared channel (PUSCH). The payload size may be decided by the corresponding aperiodic channel state information (CSI) report 236c format with all the requested information. The length of the symbols Q′ for multiplexing on the physical uplink shared channel (PUSCH) may be calculated with the payload of the extended aperiodic channel state information (CSI) report 236c.

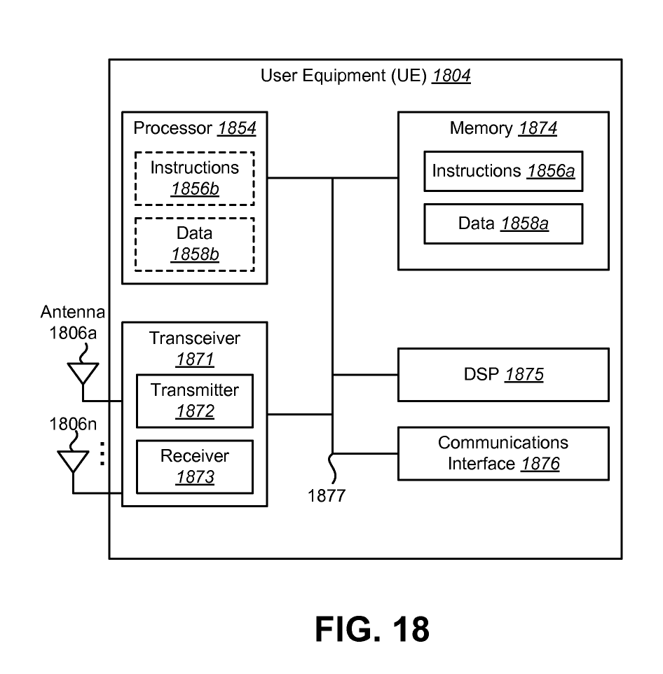

FIG. 18 illustrates various components that may be utilized in a user equipment (UE) 1804. The user equipment (UE) 1804 may be utilized as the user equipment (UE) 104 illustrated previously. The user equipment (UE) 1804 includes a processor 1854 that controls operation of the user equipment (UE) 104 1804. The processor 1854 may also be referred to as a CPU. Memory 1874, which may include both read-only memory (ROM), random access memory (RAM) or any type of device that may store information, provides instructions 1856a and data 1858a to the processor 1854. A portion of the memory 1874 may also include non-volatile random access memory (NVRAM). Instructions 1856b and data 1858b may also reside in the processor 1854. Instructions 1856b and/or data 1858b loaded into the processor 1854 may also include instructions 1856a and/or data 1858a from memory 1874 that were loaded for execution or processing by the processor 1854. The instructions 1856b may be executed by the processor 1854 to implement the systems and methods disclosed herein.

The user equipment (UE) 1804 may also include a housing that contains a transmitter 1872 and a receiver 1873 to allow transmission and reception of data. The transmitter 1872 and receiver 1873 may be combined into a transceiver 1871. One or more antennas 1806a-n are attached to the housing and electrically coupled to the transceiver 1871.

The various components of the user equipment (UE) 1804 are coupled together by a bus system 1877 which may include a power bus, a control signal bus, and a status signal bus, in addition to a data bus. However, for the sake of clarity, the various buses are illustrated in FIG. 18 as the bus system 1877. The user equipment (UE) 1804 may also include a digital signal processor (DSP) 1875 for use in processing signals. The user equipment (UE) 1804 may also include a communications interface 1876 that provides user access to the functions of the user equipment (UE) 1804. The user equipment (UE) 1804 illustrated in FIG. 18 is a functional block diagram rather than a listing of specific components.

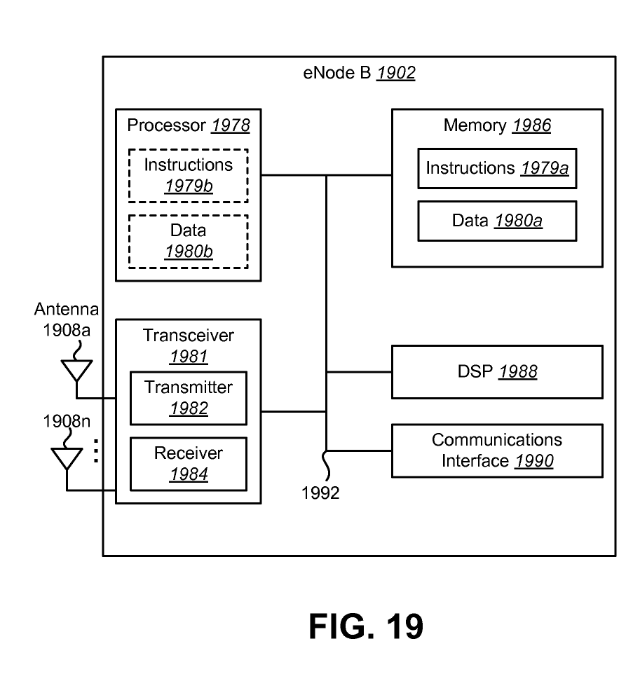

FIG. 19 illustrates various components that may be utilized in an eNode B 1902. The eNode B 1902 may be utilized as the eNode B 102 illustrated previously. The eNode B 1902 may include components that are similar to the components discussed above in relation to the user equipment (UE) 1804, including a processor 1978, memory 1986 that provides instructions 1979a and data 1980a to the processor 1978, instructions 1979b and data 1980b that may reside in or be loaded into the processor 1978, a housing that contains a transmitter 1982 and a receiver 1984 (which may be combined into a transceiver 1981), one or more antennas 1908a-n electrically coupled to the transceiver 1981, a bus system 1992, a DSP 1988 for use in processing signals, a communications interface 1990 and so forth.

Unless otherwise noted, the use of ‘1’ above represents the phrase “and/or”.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reporting uplink control information (UCI) by a user equipment (UE), comprising:
determining that multiple channel state information (CSI) reports are scheduled on a physical uplink shared channel (PUSCH);
generating an aggregated CSI report using two or more of the multiple CSI reports; and
transmitting the aggregated CSI report on the PUSCH.

2. The method of claim 1, wherein the multiple CSI reports comprise multiple periodic CSI reports.

3. The method of claim 2, wherein generating an aggregated CSI report comprises concatenating the multiple periodic CSI reports with component carrier (CC) ordering for each type of CSI report, and wherein transmitting the aggregated CSI report on the PUSCH comprises multiplexing multiple aggregated CSI reports on the PUSCH as one composite CSI block.

4. The method of claim 1, further comprising receiving a trigger from an eNode B to generate an aperiodic CSI report, wherein the multiple CSI reports comprise multiple aperiodic CSI reports.

5. The method of claim 4, further comprising generating multiple component carrier (CC) specific aperiodic CSI reports, wherein generating an aggregated CSI report comprises concatenating the multiple CC specific aperiodic CSI reports, and wherein transmitting the aggregated CSI report on the PUSCH comprises multiplexing the aggregated aperiodic CSI report on the PUSCH.

6. The method of claim 5, wherein the aggregated CSI report comprises an aggregated channel quality indicator (CQI) and/or precoding matrix indicator (PMI) and aggregated rank information (RI).

7. The method of claim 1, further comprising receiving a trigger from an eNode B to generate an instance of aperiodic CSI report, wherein the multiple CSI reports comprise the instance of aperiodic CSI report and one or more periodic CSI reports.

8. The method of claim 7, wherein it is determined that multiple CSI reports on the PUSCH is supported, and wherein the aggregated CSI report is generated using both the instance of aperiodic CSI report and the one or more periodic CSI reports.

9. The method of claim 7, wherein it is determined that multiple CSI reports on the PUSCH is not supported, and wherein the aggregated CSI report is generated using only the instance of aperiodic CSI report on the PUSCH.

10. The method of claim 7, wherein it is determined that multiple CSI reports on the PUSCH is supported, and further comprising determining whether the aperiodic CSI report is for all configured/activated component carriers (CCs).

11. The method of claim 10, wherein it is determined that the aperiodic CSI report is for all configured/activated CCs, and wherein the aggregated CSI report is generated using only the instance of aperiodic CSI report.

12. The method of claim 10, wherein it is determined that the aperiodic CSI report is not for all configured/activated CCs, and wherein the aggregated CSI report comprises the instance of aperiodic CSI report and one or more periodic CSI reports.

13. The method of claim 12, wherein the one or more periodic CSI reports correspond to CCs that are not in included in the instance of aperiodic CSI report.

14. The method of 12, wherein the aggregated CSI report is generated using an aperiodic CSI process to encode the instance of aperiodic CSI report and a periodic CSI process to encode the one or more periodic CSI reports.

15. The method of claim 1, further comprising receiving a trigger from an eNode B to generate an instance of aperiodic CSI report, wherein the aggregated CSI report comprises an extended aperiodic CSI report, and wherein the extended aperiodic CSI report comprises elements of the instance of aperiodic CSI report and CSI of component carriers that were not represented in the instance of aperiodic CSI report.

16. The method of claim 1, wherein the UE is configured for simultaneous physical uplink control channel (PUCCH) and PUSCH transmissions.

17. A user equipment (UE) configured for reporting uplink control information (UCI), comprising:
a processor;
memory in electronic communication with the processor;
instructions stored in the memory, the instructions being executable to:
determine that multiple channel state information (CSI) reports are scheduled on a physical uplink shared channel (PUSCH);
generate an aggregated CSI report using two or more of the multiple CSI reports; and
transmit the aggregated CSI report on the PUSCH.

18. The UE of claim 17, wherein the multiple CSI reports comprise multiple periodic CSI reports.

19. The UE of claim 18, wherein the instructions executable to generate an aggregated CSI report comprise instructions executable to concatenate the multiple periodic CSI reports with component carrier (CC) ordering for each type of CSI report, and wherein the instructions executable to transmit the aggregated CSI report on the PUSCH comprise instructions executable to multiplex multiple aggregated CSI reports on the PUSCH as one composite CSI block.

20. The UE of claim 17, wherein the instructions are further executable to receive a trigger from an eNode B to generate an aperiodic CSI report, wherein the multiple CSI reports comprise multiple aperiodic CSI reports.

21. The UE of claim 20, wherein the instructions are further executable to generate multiple component carrier (CC) specific aperiodic CSI reports, wherein the instructions executable to generate an aggregated CSI report comprise instructions executable to concatenate the multiple CC specific aperiodic CSI reports, and wherein the instructions executable to transmit the aggregated CSI report on the PUSCH comprise instructions executable to multiplex the aggregated aperiodic CSI report on the PUSCH.

22. The UE of claim 21, wherein the aggregated CSI report comprises an aggregated channel quality indicator (CQI) and/or precoding matrix indicator (PMI) and aggregated rank information (RI).

23. The UE of claim 17, wherein the instructions are further executable to receive a trigger from an eNode B to generate an instance of aperiodic CSI report, wherein the multiple CSI reports comprise the instance of aperiodic CSI report and one or more periodic CSI reports.

24. The UE of claim 23, wherein it is determined that multiple CSI reports on the PUSCH is supported, and wherein the aggregated CSI report is generated using both the instance of aperiodic CSI report and the one or more periodic CSI reports.

25. The UE of claim 23, wherein it is determined that multiple CSI reports on the PUSCH is not supported, and wherein the aggregated CSI report is generated using only the instance of aperiodic CSI report on the PUSCH.

26. The UE of claim 23, wherein it is determined that multiple CSI reports on the PUSCH is supported, and wherein the instructions are further executable to determine whether the aperiodic CSI report is for all configured/activated component carriers (CCs).

27. The UE of claim 26, wherein it is determined that the aperiodic CSI report is for all configured/activated CCs, and wherein the aggregated CSI report is generated using only the instance of aperiodic CSI report.

28. The UE of claim 26, wherein it is determined that the aperiodic CSI report is not for all configured/activated CCs, and wherein the aggregated CSI report comprises the instance of aperiodic CSI report and one or more periodic CSI reports.

29. The UE of claim 28, wherein the one or more periodic CSI reports correspond to CCs that are not in included in the instance of aperiodic CSI report.

30. The UE of 28, wherein the aggregated CSI report is generated using an aperiodic CSI process to encode the instance of aperiodic CSI report and a periodic CSI process to encode the one or more periodic CSI reports.

31. The UE of claim 17, wherein the instructions are further executable to receive a trigger from an eNode B to generate an instance of aperiodic CSI report, wherein the aggregated CSI report comprises an extended aperiodic CSI report, and wherein the extended aperiodic CSI report comprises elements of the instance of aperiodic CSI report and CSI of component carriers (CC) that were not represented in the instance of aperiodic CSI report.

32. The UE of claim 17, wherein the UE is configured for simultaneous physical uplink control channel (PUCCH) and PUSCH transmissions.
